(19) United States
(12) Patent Application Publication
(10) Pub. No.: US 2009/0125692 A1
(43) Pub. Date: May 14, 2009

(54) BACKUP SYSTEM AND METHOD

(76) Inventors: Masayuki YAMAMOTO, Sagamihara (JP); Yoshiaki Eguchi, Yokohama (JP); Akira Yamamoto, Sagamihara (JP); Yasutomo Yamamoto, Sagamihara (JP); Manabu Kitamura, Kawasaki (JP); Al Satoyama, Sagamihara (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/275,289

(22) Filed: Nov. 21, 2008

(30) Foreign Application Priority Data
Oct. 24, 2007 (JP) 2007-276254
Nov. 22, 2007 (JP) 2007-303741
Jun. 10, 2008 (JP) 2008-151288
Oct. 22, 2008 (JP) 2008-272545

(51) Int. Cl. G06F 12/16

(52) U.S. Cl. 711/162; 711/E12.103

(57) ABSTRACT

A storage system, upon receiving a marker from a host computer, executes a generation determination process for determining a generation of a first logical volume that is used by a host computer, and writes information related to the generation determined in this generation determination process to a physical storage device and/or a memory. A backup controller determines whether or not any data or a specified file and/or folder inside the first logical volume of the immediately preceding generation has changed, and when the result of this determination is affirmative, sends a marker insert indication, which induces the issuance of a marker, to the host computer, and when the result of the determination is negative, does not send the marker insert indication to the host computer.

### CROSS-REFERENCE TO PRIOR APPLICATION

This application relates to and claims the benefit of priority from Japanese Patent Application number 2007-276254, filed on Oct. 24, 2007, Japanese Patent Application number 2007-303741, filed on Nov. 22, 2007, Japanese Patent Application number 2008-151288, filed on Jun. 10, 2008 and Japanese Patent Application number 2008-272545, filed on Oct. 22, 2008 the entire disclosure of which are incorporated herein by reference.

### BACKGROUND

The present invention generally relates to a storage system group configured by one or more storage systems, and more particularly to data backup.

For example, the snapshot function and journal function are known as functions of a storage system.

The snapshot function holds an image of a certain logical volume at a certain point in time (for example, the point in time at which a snapshot acquisition request was received from the host). Executing the snapshot function regularly makes it possible to intermittently acquire replications (backups) of data inside a logical volume. Further, when the snapshot function is used, it is possible to restore the logical volume of the point in time at which the snapshot was acquired.

When write data is written to a logical volume specified by a write command from the host computer, the journal function creates data (a journal) comprising this write data and control information related to the writing thereof, and stores the created journal.

Japanese Patent Application Laid-open No. 2005-18738 discloses a recovery process, which is executed at a point in time other than the point at which a snapshot was created by writing the write data inside a journal to a snapshot acquired via the snapshot function.

Japanese Patent Application Laid-open No. 2007-80131 has a disclosure for switching a snapshot and a journal.

Japanese Patent Application Laid-open No. 2007-133471 has a disclosure for manipulating a snapshot restore volume.

### SUMMARY

A backup of data (hereinafter backup data) inside a primary logical volume (hereinafter, P-VOL) used by a host computer is acquired using a snapshot function or a journal function. A small amount of backup data is preferable. This is because, when backup data is stored inside a storage system having a P-VOL, for example, if the amount of backup data is small, less storage capacity will be consumed. Further, for example, when backup data is transferred from this storage system to another storage system, if the amount of backup data is small, the backup can be executed in a short period of time since the amount of data being transferred is small, and, in addition, less storage capacity will be consumed in the other storage system.

Therefore, an object of the present invention is to provide a technique that reduces the amount of backup data.

A backup system according to a first aspect of the present invention comprises a storage system having a first logical volume that is accessed from a host computer; and a backup controller for controlling the backup of data that is inside the above-mentioned first logical volume. The above-mentioned storage system comprises a physical storage device that constitutes the basis of one or more logical volumes including the above-mentioned first logical volume and a journal area; and a controller, which has a memory, and which receives a write command and write data element from the above-mentioned host computer, and writes the above-mentioned write data element to the above-mentioned first logical volume specified from the above-mentioned write command. The above-mentioned journal area is a storage area in which is stored a journal data element, which is either a data element that is stored in any block of a plurality of blocks that configure a logical volume, or a data element that is written to this block. The above-mentioned host computer sends a marker, which is a snapshot acquisition request, to the above-mentioned storage system in response to receiving a marker insert indication, which is a snapshot create indication, from the above-mentioned backup controller. The above-mentioned controller, upon receiving a marker from the above-mentioned host computer, executes a generation determination process for determining a generation of the above-mentioned first logical volume, and writes information related to the generation determined in the above-mentioned generation determination process to the above-mentioned physical storage device and/or the above-mentioned memory. The above-mentioned backup controller:

(1-1) determines whether or not any data or specified file and/or folder inside the above-mentioned first logical volume of the immediately preceding generation has changed;
(1-2) sends the above-mentioned marker insert indication to the above-mentioned host computer when the result of the determination in the above-mentioned (1-1) is affirmative; and
(1-3) does not send the above-mentioned marker insert indication to the above-mentioned host computer when the result of the determination in the above-mentioned (1-1) is negative.

A backup system according to a second aspect of the present invention comprises a storage system having a first logical volume that is accessed from a host computer; another storage system that is connected to the above-mentioned storage system; and a backup controller for controlling a backup of data that is inside the above-mentioned first logical volume. The above-mentioned storage system comprises a physical storage device that constitutes the basis of one or more logical volumes including the above-mentioned first logical volume and a journal area; and a controller, which has a memory, and which receives a write command and write data element from the above-mentioned host computer and writes the above-mentioned write data element to the above-mentioned first logical volume specified from the above-mentioned write command. The above-mentioned journal area is a storage area in which is stored a journal data element, which is either a data element that is stored in any block of a plurality of blocks that configure a logical volume, or a data element that is written to this block. The above-mentioned controller has a restore processor that creates a restore volume corresponding to the above-mentioned first logical volume in a certain generation. The backup controller specifies a file and/or folder that has changed from a certain generation to the latest generation by comparing a restore volume against a first logical volume, and, of the data inside the restore volume, backs up only the above-mentioned specified file and/or folder to the other storage system.

### BRIEF DESCRIPTION OF THE DRAWINGS

FIG. 1 shows the configuration of a computer system related to a first embodiment of the present invention;

FIG. 2 shows an overview of the configuration of the storage area in a first storage system;

FIG. 3 shows an overview of the storage of a JNL data element;

FIG. 4 shows the computer programs and information stored in the control memory inside the first storage system;

FIG. 5 shows examples of the configuration management table, JNL area management table, backup generation management table and first JNL management table shown in FIG. 4;

FIG. 6 shows a data management scheme that takes inter-generational difference data as an example from among online update difference data, inter-generational difference data and merge difference data;

FIG. 7 shows the flow of a host write size configuration process;

FIG. 8 shows the flow of a write process that writes a write data element to a P-VOL;

FIG. 9 shows marker reception and the flow of processing carried out in response to marker reception;

FIG. 10 shows the flow of a sort process of the first embodiment;

FIG. 11 is the flow of a merge process of the first embodiment;

FIG. 12 shows the movement of data elements related to the merge process of the first embodiment;

FIG. 13 shows the flow of a restore process;

FIG. 14 shows the flow of a read process that uses an R-VOL management table;

FIG. 15 shows the flow of a write process that uses an R-VOL management table;

FIG. 16 is the configuration of a computer system in a second embodiment of the present invention;

FIG. 17A is an example of a backup configuration table of the second embodiment of the present invention, and FIG. 17B is an example of a recovery point management table of the second embodiment of the present invention;

FIG. 18 is a diagram showing the flow of processing of a backup configuration management program of the second embodiment of the present invention;

FIG. 19 is a diagram showing the flow of processing of a backup operation program of the second embodiment of the present invention;

FIG. 20 is a diagram showing the flow of processing of a recovery point management program of the second embodiment of the present invention;

FIG. 21 is a diagram showing the flow of processing of a recovery operation program of the second embodiment of the present invention;

FIG. 22 is a diagram showing an example of a screen displayed by the backup configuration management program of the second embodiment of the present invention;

FIG. 23 is a diagram showing a variation of the screen displayed by the backup configuration management program of the second embodiment of the present invention;

FIG. 24 is a diagram showing an example of a screen displayed by the backup operation program of the second embodiment of the present invention;

FIG. 25 is a diagram showing an example of a screen displayed by the recovery point management program of the second embodiment of the present invention;

FIG. 26 is a diagram showing an example of a screen displayed by the recovery operation program of the second embodiment of the present invention;

FIG. 27 is a diagram showing a variation of the screen displayed by the recovery operation program of the second embodiment of the present invention;

FIG. 28 shows the flow of a sort process in which there is a R-VOL;

FIG. 29 is a diagram showing an overview of a third embodiment of the present invention;

FIG. 30 is the configuration of a computer system of the third embodiment of the present invention;

FIG. 31 is an example of a tape generation management table of the third embodiment of the present invention;

FIG. 32 is a diagram showing the flow of processing of a tape backup program of the third embodiment of the present invention;

FIG. 33 is a diagram showing the flow of processing of a disk restore program of the third embodiment of the present invention; and

FIG. 34 is a diagram showing a modified address area inside an R-VOL, and a file related to this area.

### DESCRIPTION OF THE PREFERRED EMBODIMENTS

A number of embodiments of the present invention will be explained hereinbelow by referring to the figures.

### Embodiment 1

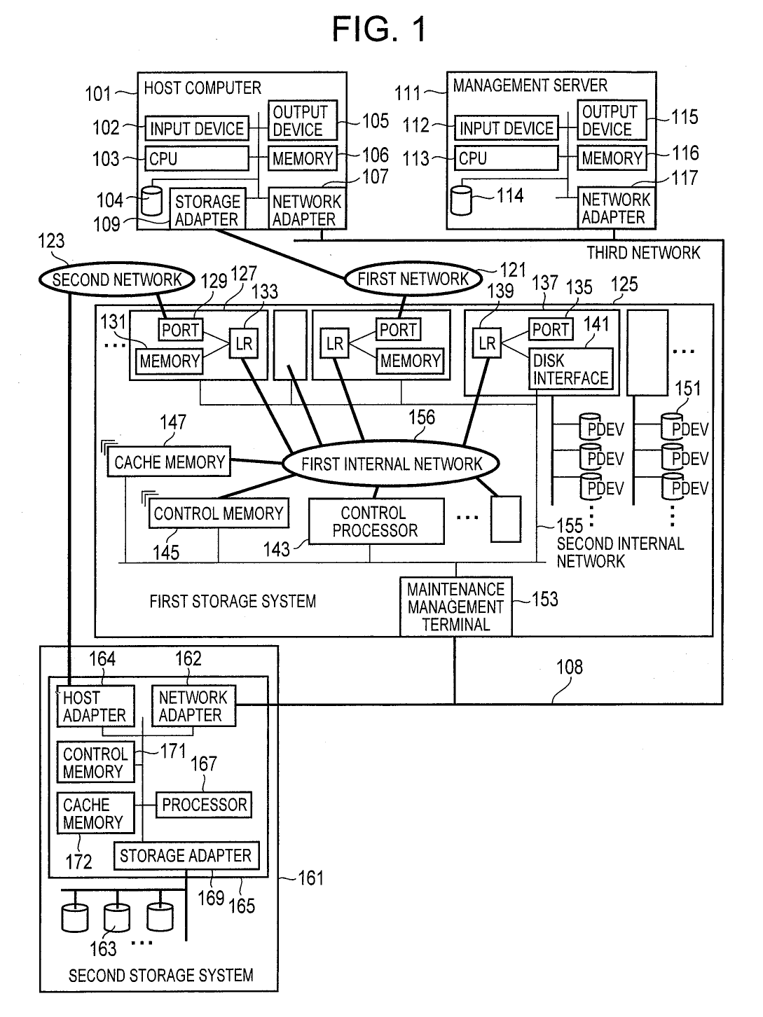

FIG. 1 shows the configuration of a computer system related to a first embodiment of the present invention.

One or more host computers 101 and a first storage system 125 are connected to a first network 121. The first storage system 125 and a second storage system 161 are connected to a second network 123. The one or more host computers 101, a management server 111, and the first and second storage systems 125 and 161 are connected to a third network 108. The networks 121, 123 and 108 can each employ an arbitrary type of network. For example, the first and second networks 121 and 123 are SAN (Storage Area Network), and the third network 108 is a LAN (Local Area Network). Further, for example, the storage systems 125 and 161 can be connected via a leased line instead of the second network 123. Further, the second storage system 161 can be an external connection-destination storage system, or a remote copy-destination storage system.

The host computer 101 accesses a logical volume provided from the first storage system 125. The host computer 101 comprises a CPU (Central Processing Unit) 103, memory 106, auxiliary storage device 104, input devices (for example, a keyboard and a pointing device) 102, output device (for example, a display device) 105, storage adapter (for example, a host bus adapter) 109 connected to the first network 121, and a network adapter 107 connected to the third network 108. The CPU 103 sends an I/O command (either a write command or a read command) specifying an address via the storage adapter 109.

The management server 111 is a computer that manages the apparatuses 101, 111, 125 and 161 connected to the third network 108. The management server 111 comprises a CPU (Central Processing Unit) 113, memory 116, auxiliary storage device 114, input devices (for example, a keyboard and pointing device) 112, output device (for example, a display device) 115, and a network adapter 117 that is connected to the third network 108. The CPU 113 sends commands to the apparatuses 101, 111, 125 and 161 connected to the third network 108 via the network adapter 117.

The first storage system 125 has a controller and a storage device group. The controller, for example, comprises a plurality of front-end interfaces 127, a plurality of backend interfaces 137, a first internal network 156, one or more cache memories 147, one or more control memories 145, and one or more processors 143. The storage device group is configured from a plurality of physical storage devices (hereinafter, referred to as “PDEV”) 151.

The front-end interface 127 is an interface circuit for communicating with either apparatus 101 or 161, which are external to the first storage system 125. Therefore, the front-end interface 127 can include an interface connected to the first network 121 and an interface connected to the second network 123. The front-end interface 127, for example, has a port 129 that is connected to either network 121 or 123, a memory 131, and a local router (hereinafter, abbreviated as “LR”) 133. The port 129 and memory 131 are connected to the LR 133. The LR 133 carries out the distribution of data received by way of the port 129 for processing by an arbitrary processor 143. More specifically, for example, the configuration from a processor 143 to the LR 133 is such that an I/O command specifying a certain address is carried out by this processor 143, and the LR 133 distributes the I/O command and data in accordance with this configuration.

The backend interface 137 is an interface circuit for communicating with the PDEV 151. The backend interface 137, for example, has a disk interface 141 that is connected to the PDEV 151, a memory 135, and a LR 139. The disk interface 141 and memory 135 are connected to the LR 139.

The first internal network 156, for example, is configured from a switch (as one example, a crossbar switch) or a bus. The plurality of front-end interfaces 127, plurality of backend interfaces 137, one or more cache memories 147, one or more control memories 145, and one or more processors 143 are connected to the first internal network 156. Communications among these elements is carried out by way of the first internal network 156.

The cache memory 147 is a memory for temporarily storing either read-out or written data in accordance with an I/O command from the host computer 101.

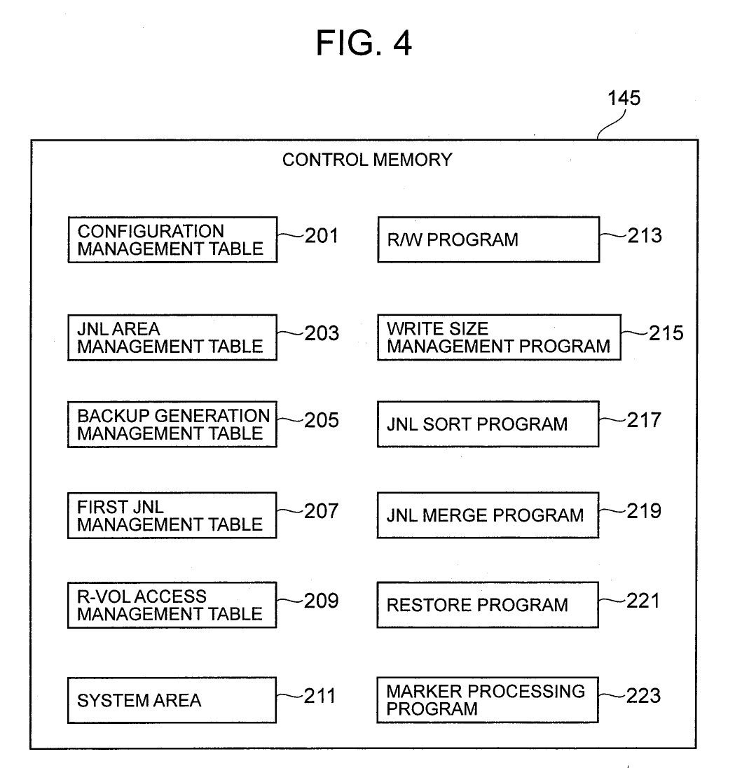

The control memory 145 is for storing various computer programs and/or information (for example, the computer programs and information shown in FIG. 4). For example, the control memory 145 stores information indicating which P-VOL (primary logical volume) is the VOL to be accessed from what host computer, information indicating which P-VOL configures a pair with which S-VOL (secondary logical volume), and information indicating which P-VOL is associated to which R-VOL (restored logical volume). From this information, it is possible to specify which S-VOL and R-VOL are logical volumes related to which host computer. As will be described hereinbelow, when the first storage system 125 receives the host write size for a certain host computer, the control processor 143 can specify the P-VOL, S-VOL and R-VOL related to this certain host computer by referencing information that is stored in the control memory 145, and can configure the host write size for the specified P-VOL, S-VOL and R-VOL.

The processor 143 carries out the processing described hereinbelow by executing the various computer programs stored in the control memory 145.

The PDEV 151 is a nonvolatile storage device, for example, a hard disk drive or a flash memory device. A RAID (Redundant Array of Independent Disks) group, which is a PDEV group that accords with RAID rules, is configured using two or more PDEV 151.

A second internal network (for example, a LAN) 155 is connected to the respective components 127, 137, 147, 145 and 143 of the controller, and a maintenance management terminal 153 is connected to this second internal network 155. The maintenance management terminal 153 is also connected to the third network 108, and is a computer for either maintaining or managing the first storage system 125. The maintenance personnel for the first storage system 125, for example, can operate the maintenance management terminal 153 (or the management server 111, which is capable of communicating with this terminal 153) to define various information to be stored in the control memory 145.

The second storage system 161 has a controller 165, and a group of PDEV 163. The controller 165, for example, has a host adapter 164, network adapter 162, control memory 171, cache memory 172, processor 167, and storage adapter 169. The functions of the host adapter 164, network adapter 162, control memory 171, cache memory 172, processor 167 and storage adapter 169 are respectively substantially the same as the functions of the front-end interface 127, network adapter 162, control memory 145, cache memory 147, processor 167, and backend interface 137.

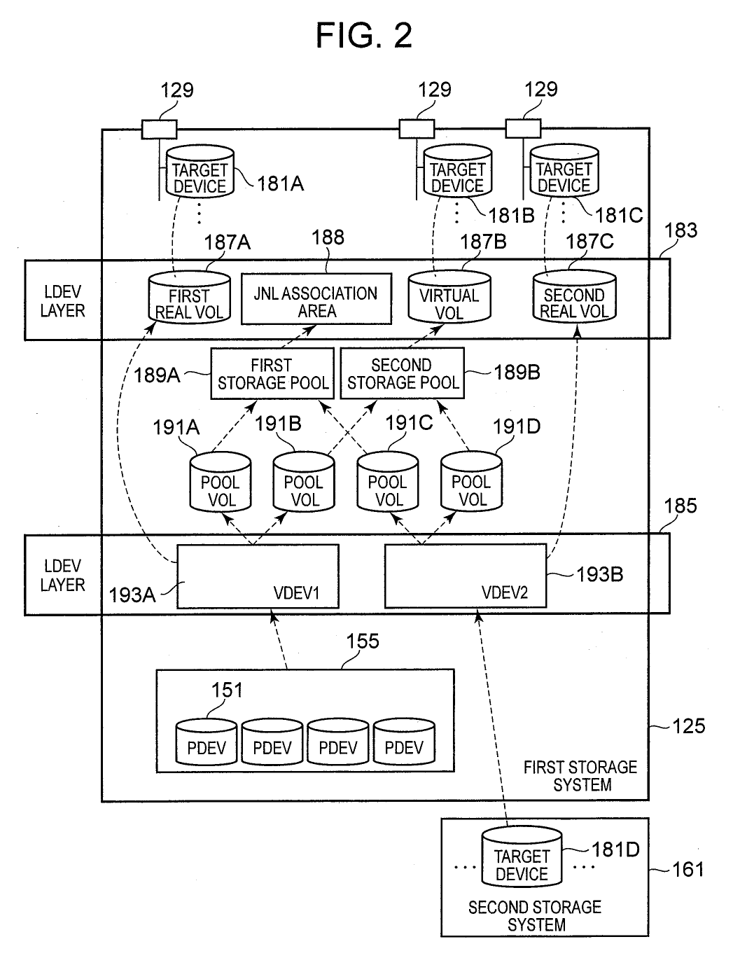

FIG. 2 shows an overview of the configuration of the storage area in the first storage system 125.

The logical storage hierarchy includes, in order from the lower-level to the higher-level, a VDEV layer 185, storage pools 189A and 189B, and an LDEV layer 183.

One or more virtual devices (VDEV) are in the VDEV layer 185. The VDEV is a storage area in which a prescribed address range is configured. Each of the plurality of storage area parts that configure this storage area is a logical volume.

In the example of FIG. 2, a first VDEV 193A is a substantive storage area provided by one RAID group 195. The first VDEV 193A, for example, constitutes the basis of a first real VOL 187A and pool VOL 191A and 191B. Therefore, data written to these logical volumes 187A, 191A and 191B is actually being written to the RAID group 195 that forms the basis of the first VDEV 193A.

Meanwhile, a second VDEV 193B is a virtual storage area. The second VDEV 193B constitutes the basis of a second real VOL 187C, and pool VOL 191C and 191D. Therefore, data written to these logical volumes 187C, 191C and 191D is actually written to storage resources (for example, a RAID group) inside the second storage system 161, which constitutes the basis of the second VDEV 193B. More specifically, for example, the storage area part corresponding to the second real VOL 187C is allocated to a target device 181D inside the second storage system 161, and, in this case, data written to the virtual VOL 187C is actually transferred to the second storage system 161, and written to the logical volume allocated to the target device 181D.

A storage pool is a cluster of one or more pool VOL. In the example of FIG. 2, a first storage pool 189A is a cluster of pool VOL 191A and 191C, and second storage pool 189B is a cluster of pool VOL 191B and 191D. Pool VOL 191A through 191D are logical volumes that are not associated to the target devices 181A through 181C (that is, logical volumes not provided to the host computer 101). Furthermore, all of the pool VOL inside the first storage system 125 can be created on the basis of the VDEV based on the RAID group inside the first storage system 125, and, by contrast, can also be created on the basis of the VDEV based on the storage resources inside the second storage system 161.

There is a plurality of logical volumes 187A through 187C and a JNL association area 188 in the LDEV layer 183 (“JNL” is the abbreviation for journal). Unlike the pool VOL, all of the logical volumes 187A through 187C are capable of being recognized by the host computer 101. According to the example of FIG. 2, logical volume 187A is a substantive storage area (hereinafter referred to as the “first real VOL”) inside the first storage system 125. Logical volume 187B is a virtual logical volume (hereinafter referred to as a “virtual VOL”) associated to storage pool 189B. For example, virtual VOL 187B is configured from a plurality of virtual areas, and storage pool 189B is configured from a plurality of pool areas. As a result of data being written to a virtual area inside virtual VOL 187B, a pool area is allocated from storage pool 189B to this virtual area, and the write-targeted data is written to this pool area. If this pool area belongs to pool VOL 191B, the data is stored inside the first storage system 125, and if this pool area belongs to pool VOL 191D, this data is stored inside the second storage system 161.

The JNL association area 188 is a storage area that is not provided to the host computer 101. This area 188, for example, exists inside the first storage pool 189. This area 188 is configured by a JNCB area, which will be described further below, and a JNL area. “JNCB” is a character string that signifies a second JNL management table to be described below.

The target devices 181A through 181C are seen as logical devices by the host computer 101, and more specifically, for example, are LUN (Logical Unit Number) in an open system, and “devices” in a mainframe system. Target devices 181A through 181C are associated to a port 129 and to logical volumes 187A through 187C in the LDEV layer 183. According to the example of FIG. 2, an I/O (either a write or a read) occurs in the first real VOL 187A associated to target device 181A when this device 181A is specified in an I/O command, an I/O occurs in virtual VOL 187B associated to target device 181B when this device 181B is specified, and an I/O occurs in a second real VOL 187C associate to target device 181C when this device 181C is specified.

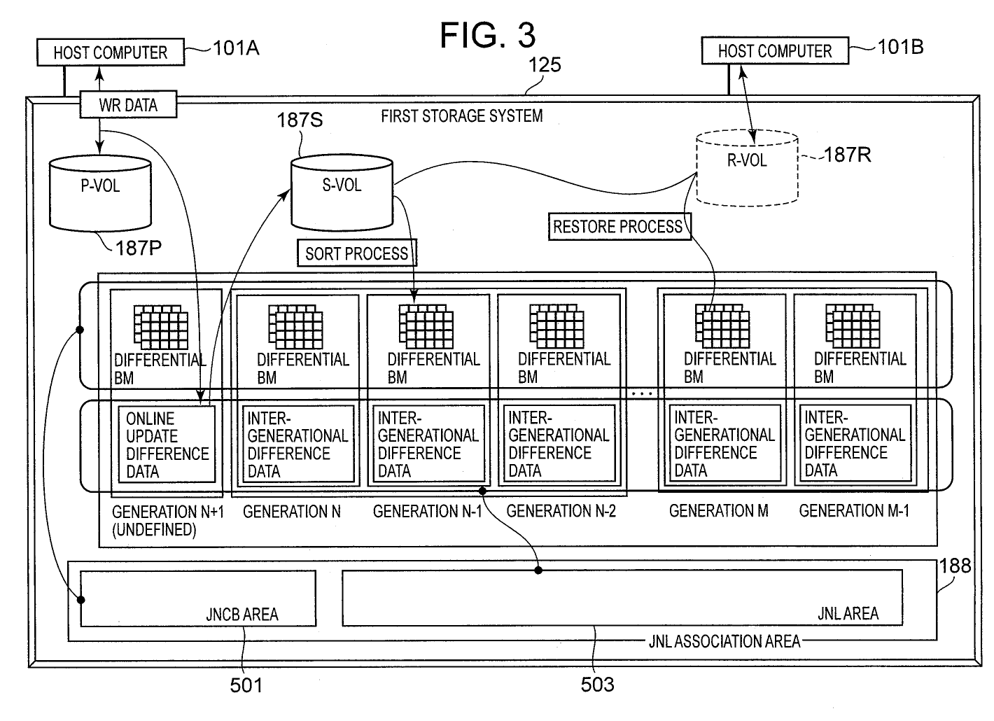

FIG. 3 shows an overview of the storage of a JNL data element. Furthermore, in FIG. 3, the word “write” is abbreviated as “WR”, and write may also be abbreviated in this way in other figures as well.

A P-VOL 187P and an S-VOL 187S are in the first storage system 125. Further, P-VOL 187P and S-VOL 187S, which can construct R-VOL 187R, for example, are either the above-described first or second real VOL 187A or 187C, and R-VOL 187R is the above-described virtual VOL 187B.

P-VOL 187P is a primary logical volume (online logical volume). P-VOL 187P is updated by write data being written in from the host computer 101.

S-VOL 187S is a secondary logical volume that is paired up with the P-VOL 187P, and has the same storage capacity as the P-VOL 187P.

The R-VOL 187R is a logical volume that has the contents of a specified generation of the P-VOL 187P. The R-VOL 187R is a virtual volume like that described hereinabove, and, as will be explained further below, is created in response to a request from the user or administrator.

The JNL association area 188, as described above, is configured from a JNCB area 501 and a JNL area 503. As shown in FIG. 3, a differential BM (BM is the abbreviation for “bitmap”) corresponding to an undefined generation and a differential BM corresponding to each defined generation are stored in the JNCB area 501. Online update difference data corresponding to an undefined generation and online update difference data corresponding to each defined generation are stored in the JNL area 503.

Here, a “generation” is a certain point in time of the P-VOL 187P. For example, generation (N) is subsequent to generation (N−1), and is a time when a prescribed generation definition event occurred in the P-VOL 187P (in this embodiment, the time when a marker, which will be explained below, was received from the host computer 101). Furthermore, in the example of FIG. 3, since the latest generation that has been defined is generation (N), the undefined generation is generation (N+1). Because an image of the P-VOL 187P at the time the marker was received is acquired by the first storage system 125, the marker can also be called a snapshot acquisition request.

“Online update difference data” is an aggregate of online update difference data elements. The “online update difference data element” is a JNL data element of the P-VOL 187P. The “JNL data element” is an amount of JNL data the size of a P-VOL 187P unit storage area (the host write size explained hereinbelow). The JNL data element can be either an after JNL data element or a before JNL data element. The “after JNL data element” is a write data element in the P-VOL 187P. The “before JNL data element” is a data element (data element stored in the write-destination storage area of a write data element) that has been saved from the P-VOL 187P via a COW (Copy On Write) as a result of a write data element being written to the P-VOL 187P. In the following explanation, the unit storage area (the unit storage area managed in host write size units, which will be described hereinbelow) in which a data element inside a logical volume is stored may for the sake of convenience be called a “block”, and the storage area in which a data element inside the JNL area 503 is stored may for the sake of convenience be called a “segment”. Further, in the following explanation, it is supposed that an online update difference data element is an after JNL data element.

Furthermore, the maximum size of online update difference data is the same size as the P-VOL corresponding to this data. This is because the online update difference data element that corresponds to the same block of the corresponding P-VOL is overwritten inside the JNL area 503. Therefore, the maximum size of the inter-generational difference data described hereinbelow is also the same as the size of the P-VOL corresponding to this data. In other words, the size of the JNL sub-area of the write destination of the online update difference data element is the maximum size, and can be made the same size as the P-VOL (This point is also the same for the inter-generational difference data and the merge difference data to be described hereinbelow.).

The “inter-generational difference data” is an aggregate of inter-generational difference data elements. The “inter-generational difference data element” is a data element that is saved from the S-VOL 187S in accordance with a COW resulting from an online update difference data element being written to the S-VOL 187S. More specifically, for example, in a case when the undefined generation is generation (N), when the first storage system 125 receives a marker (specified electronic data) from the host computer 101, generation (N) is defined, and the undefined generation becomes (N+1). In this case, online update difference data accumulated in the JNL area 503 (that is, data equivalent to the difference between the generation (N) P-VOL 187P and the generation (N−1) P-VOL 187P) is written to the S-VOL 187S. Each time an online update difference data element is written, a data element from the S-VOL 187S is saved to the JNL area 503 via the COW as an inter-generational difference data element. Accordingly, the S-VOL 187S becomes a replicate of the generation (N) P-VOL 187P, and inter-generational difference data corresponding to generation (N−1) (that is, data equivalent to the difference between the generation (N−1) S-VOL 187S and the generation (N−2) S-VOL 187S) is stored in the JNL area 503. Thus, the S-VOL 187S generation is the generation immediately preceding the P-VOL 187P generation.

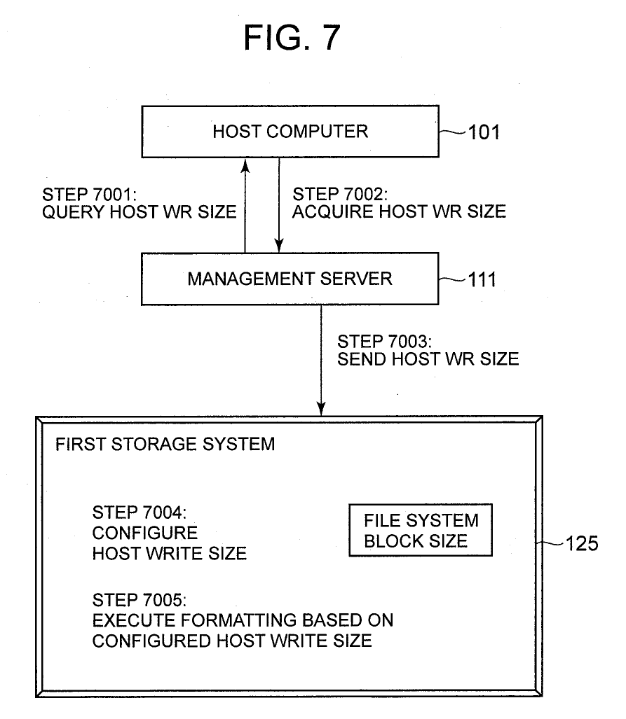

The “differential BM” is a bitmap indicating the difference between the generations of a logical volume. More specifically, for example, in the example of FIG. 3, the differential BM corresponding to generation (N) is the bitmap indicating the difference between the generation (N) P-VOL 187P and the generation (N−1) P-VOL 187P. When the write data element is first written to a certain block inside the P-VOL 187P at a certain point in time later than generation (N−1), the bit corresponding to this certain block (the bit inside the differential BM corresponding to generation (N)) is turned ON (that is, the value indicating the occurrence of a write (for example, “1”) is updated), and the online update difference data element corresponding to this write data element is stored in the JNL area 503. Furthermore, the respective bits that configure the differential BM correspond to the respective blocks of the P-VOL 187P. The size of the respective blocks constitutes the host write size in accordance with formatting that will be explained by referring to FIG. 7. The “host write size” is the unit size of data written from the host computer 101 (the size of the write data element).

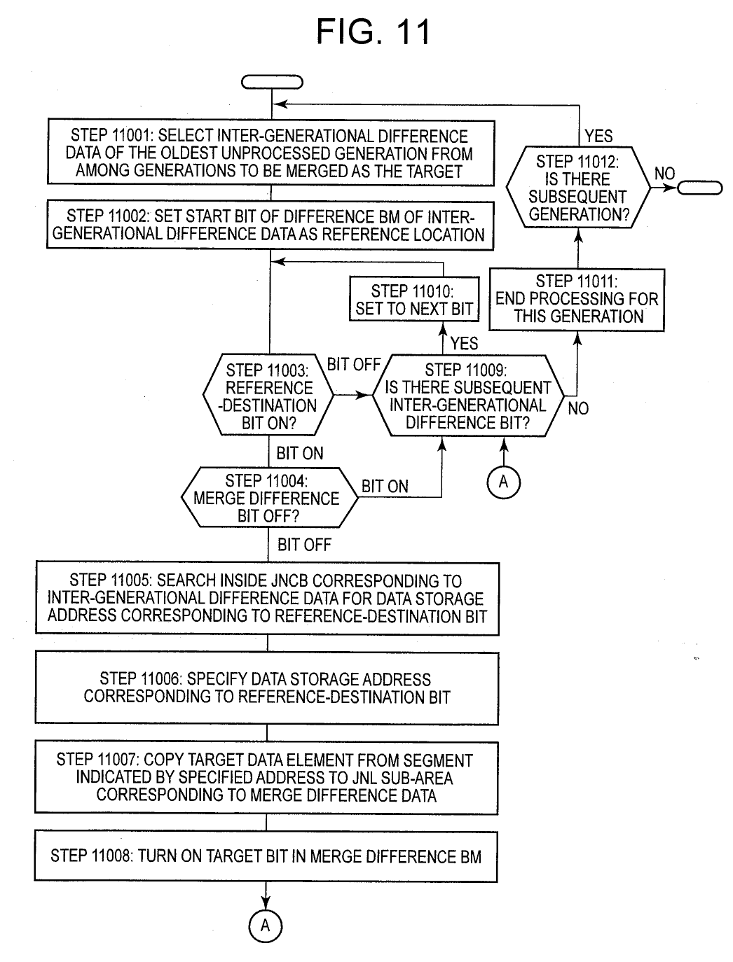

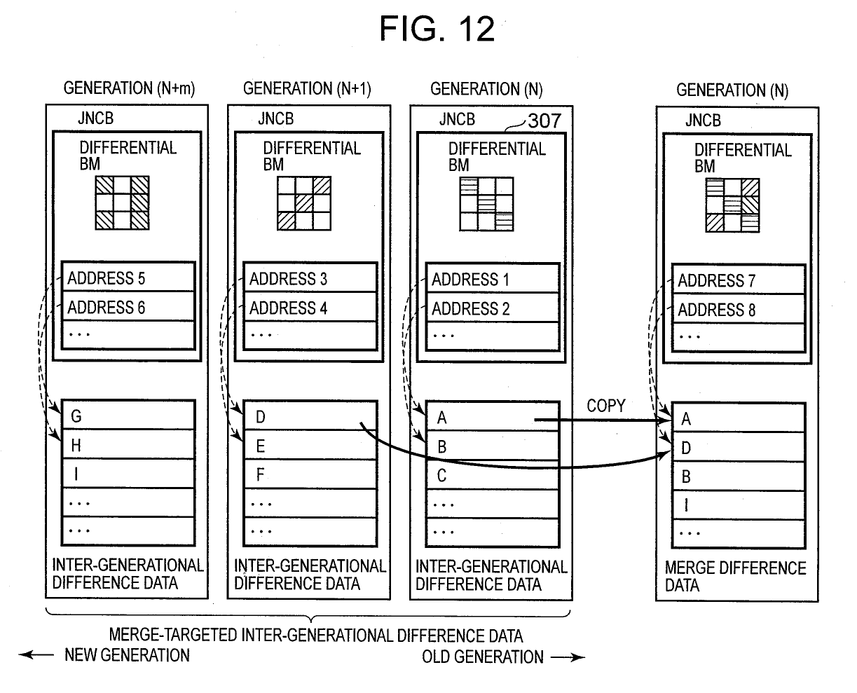

Furthermore, as will be explained further below by referring to FIGS. 11 and 12, it is possible to merge a plurality of generations' worth of inter-generational difference data and differential BM. Consequently, it is possible to reduce the storage capacity that is consumed. Hereinbelow, post-merge inter-generational difference data will be referred to as “merged difference data”.

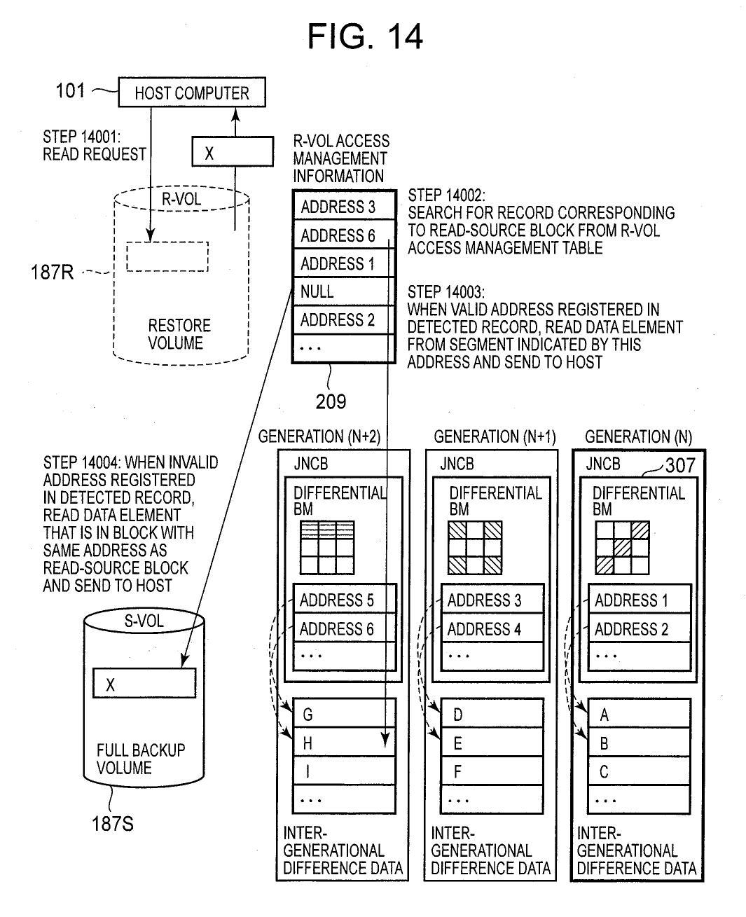

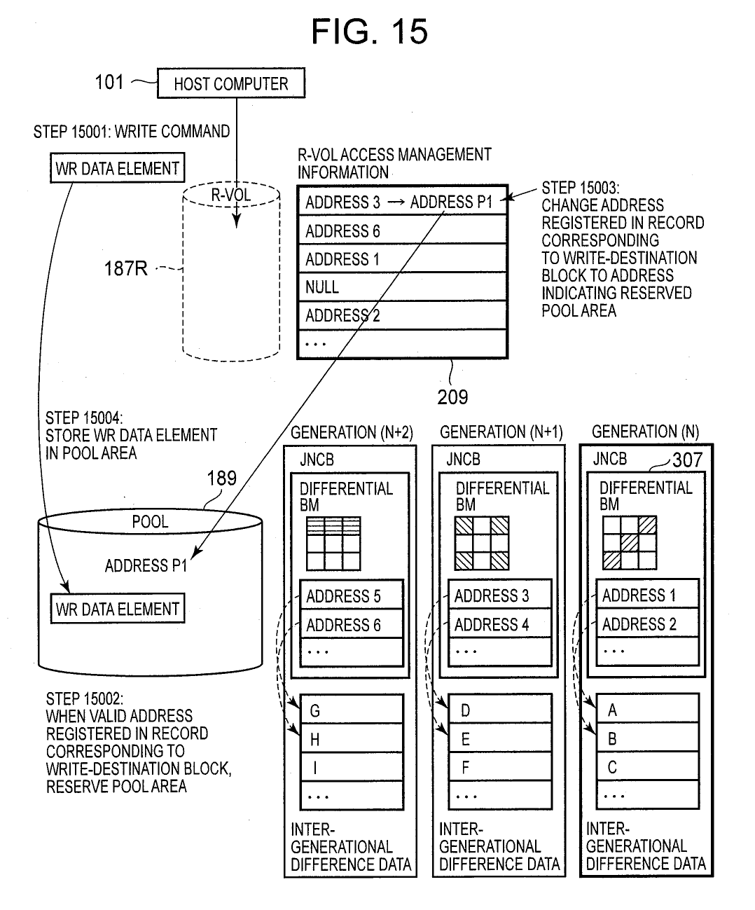

Further, in FIG. 3, a sort process and a restore process are shown. Overviews of the respective processes are as follows.

<Sort Process> Online update difference data elements are lined up (spread out) chronologically in the JNL area 503 (that is, in the order in which they were written to the JNL area 503). When the online update difference data is read out from the JNL area 503 and written to the S-VOL 187S, the online update difference data elements are read out in the order of the addresses of the P-VOL 187P (either ascending or descending address order) instead of chronologically. Thus, the online update difference data elements are written to the S-VOL 187S in address order, and as such, the inter-generational difference data elements written to the JNL area 503 from the S-VOL 187S via a COW become lined up (become spread out) in the address order of the P-VOL 187P. The process by which inter-generational difference data is lined up in address order in the JNL area 503 by reflecting the chronologically arranged online update difference data elements in the S-VOL 187S in address order is the “sort process”. Furthermore, as in the third embodiment explained hereinbelow, a sort process in a case when there is no online update difference data is carried out so as to line up inter-generational difference data in address order in the JNL area 503.

<Restore Process> The “restore process” creates the R-VOL 187R in response to a request from either the user or the administrator. It is possible to read from the R-VOL 187R. Further, it is also possible to write to the R-VOL 187R. Read and write processes for the R-VOL 187R will be explained further below by referring to FIGS. 14 and 15.

FIG. 4 shows computer programs and information stored in the control memory 145. In the following explanation, a process described as being performed by a program is actually carried out by the processor 143 that executes this program.

The control memory 145 stores a configuration management table 201, JNL area management table 203, backup generation management table 205, first JNL management table 207, R-VOL access management table 209, R/W program 213, write size management program 215, JNL sort program 217, JNL merge program 219, restore program 221, and marker processing program 223. The control memory 145 also has a system area 211. The R/W program 213 controls I/O in accordance with an I/O command from the host computer 101. The write size management program 215 configures the host write size. The JNL sort program 217 executes a sort process. The JNL merge program 219 merges a plurality of generations of inter-generational difference data. The restore program 221 creates the R-VOL 187R. The marker processing program 223 processes a marker from the host computer 101. The various programs and information stored in the control memory 145 will be explained in detail below. Further, in the following explanation, logical volume may be abbreviated as “VOL”.

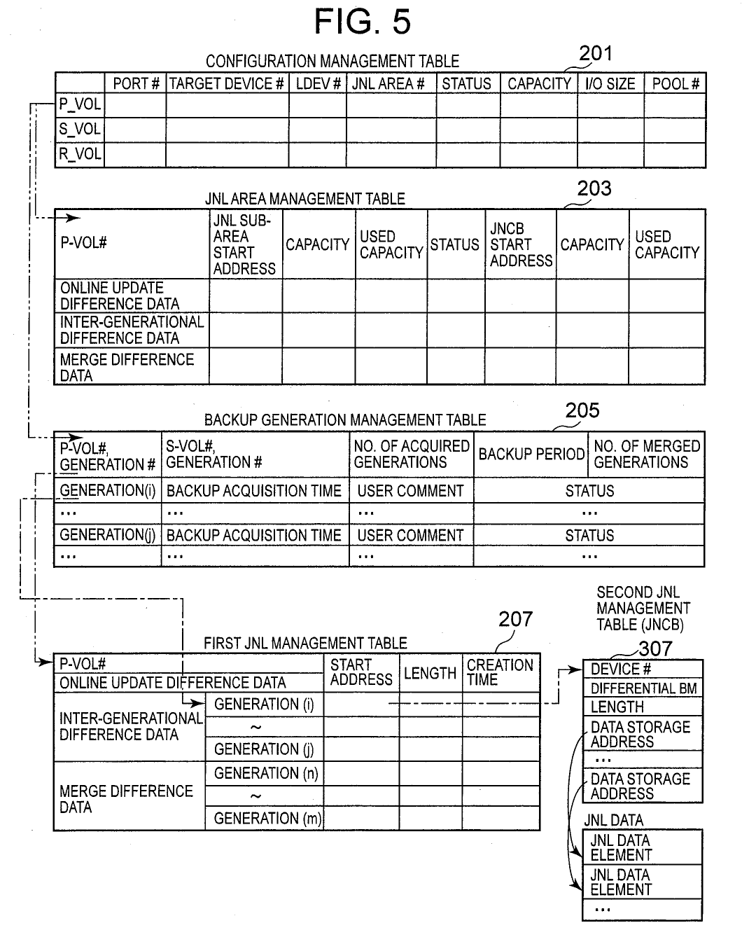

FIG. 5 shows examples of the configuration management table 201, JNL area management table 203, backup generation management table 205, and first JNL management table 207 shown in FIG. 4. Furthermore, FIG. 5 also shows a second JNL management table (JNCB) 307 and JNL data managed by a JNCB 307 that are not shown in FIG. 4, but the JNCB 307 and JNL data are stored in the PDEV group (the storage pool in the example described hereinabove) without being stored in the control memory 145.

The configuration management table 201 is provided in each P-VOL, and is for managing the P-VOL and S-VOL and the R-VOL related thereto. In the configuration management table 201, for example, are recorded a “port #” (number of the port allocated to the target device corresponding to the VOL), “target device #” (number of the target device corresponding to the VOL), “LDEV #” (number for identifying the VOL), “JNL area #” (number of the JNL area corresponding to the VOL from among a plurality of JNL areas), “status” (the status of the VOL, for example, the access restriction status, such as R/W prohibited or R only), “capacity” (the capacity of the VOL), “I/O size” (the above-mentioned host write size), and “pool #” (number of the storage pool allocated to the VOL) for each VOL of the P-VOL, and the S-VOL and R-VOL related thereto.

The JNL area management table 203 is provided in each P-VOL, and is for managing the location of online update difference data, inter-generational difference data and merge difference data corresponding to the P-VOL. More specifically, there is a “JNL sub-area start address” (address indicating the start of the JNL sub-area), “capacity” (capacity of the JNL sub-area corresponding to the data), “used capacity” (capacity occupied by data), “status” (for example, ‘normal’ if it is a state in which the JNL sub-area can be used normally, ‘blockage’ if the JNL sub-area cannot be used for one reason or another, ‘insufficient capacity’ if the free capacity of the JNL (the difference between the capacity and the used capacity) is less than a prescribed threshold), “JNCB start address” (address indicating the start of the JNCB), “capacity” (capacity of the JNCB), and “used capacity” (the capacity occupied by a JNCB group) for each of the online update difference data, inter-generational difference data, and merge difference data. Furthermore, the “JNL sub-area” is one part of the JNL area 503. Further, for the inter-generational difference data and merge difference data, a “JNL sub-area start address”, “capacity”, “used capacity”, “status”, “JNCB start address”, “capacity” and “used capacity” are registered for each generation.

The backup generation management table 205 is provided for each P-VOL, and is for managing backup data related to the P-VOL. In the backup generation management table 205, for example, there is recorded a “P-VOL #” (number of the P-VOL), “generation #” (number indicating the latest generation), “S-VOL #” (number of the S-VOL that configures a pair with the P-VOL), “generation #” (number indicating the latest generation of the S-VOL), “number of acquired generations” (number of generations of backups for the P-VOL), “backup period” and “number of merged generations” (whether a merge process was executed when a certain number of generations' worth of inter-generational difference data had accumulated). The backup generation management table 205 also has for each generation of the P-VOL a “generation #” (number indicating the generation), “backup acquisition time” (when a backup was acquired (in other words, the date and time at which the marker, which constituted the reason for defining this generation), was received), “user comment” (arbitrary user information for the user to manage a backup), backup “status” (for example, whether a backup was a success or a failure).

The first JNL management table 207 is provided for each P-VOL, and is for managing the online update difference data, inter-generational difference data, and merge difference data corresponding to the P-VOL. For online update difference data, for example, there is recorded a “start address” (start address of the JNCB), “length” (size of the online update difference data, for example, the number of online update difference data elements), “creation time” (time at which the online update difference data element was stored (for example, the time at which the marker, which constituted the reason for defining the latest generation), was received) Further, for the inter-generational difference data, “start address”, “length” and “creation time” are recorded for each generation. Furthermore, the “creation time” here is the time at which corresponding inter-generational difference data was stored in the JNL sub-area. Similarly, for the merge difference data, a “start address”, “length” and “creation time” are also recorded for each generation. Furthermore, “generation” here is a certain generation of a plurality of generations corresponding to the merge difference data (for example, either the latest or the oldest generation), and “creation time” is the time at which corresponding merge difference data was stored in the JNL sub-area. Referencing the “start address” corresponding to online update difference data and other such JNL data makes it possible to reference the JNCB corresponding to this JNL data.

The JNCB 307 exists for each generation for both the inter-generational difference data and the merge difference data. The JNCB 307 is a table for managing the locations of a differential BM and data element corresponding to a generation. More specifically, for example, the JNCB table 307 records a “device #” (number of the corresponding P-VOL), “length” (length of the corresponding JNL data (online update difference data, inter-generational difference data or merge difference data)), “differential BM” (differential BM corresponding to a generation), and data storage address corresponding to the respective JNL data elements that configure the corresponding JNL data.

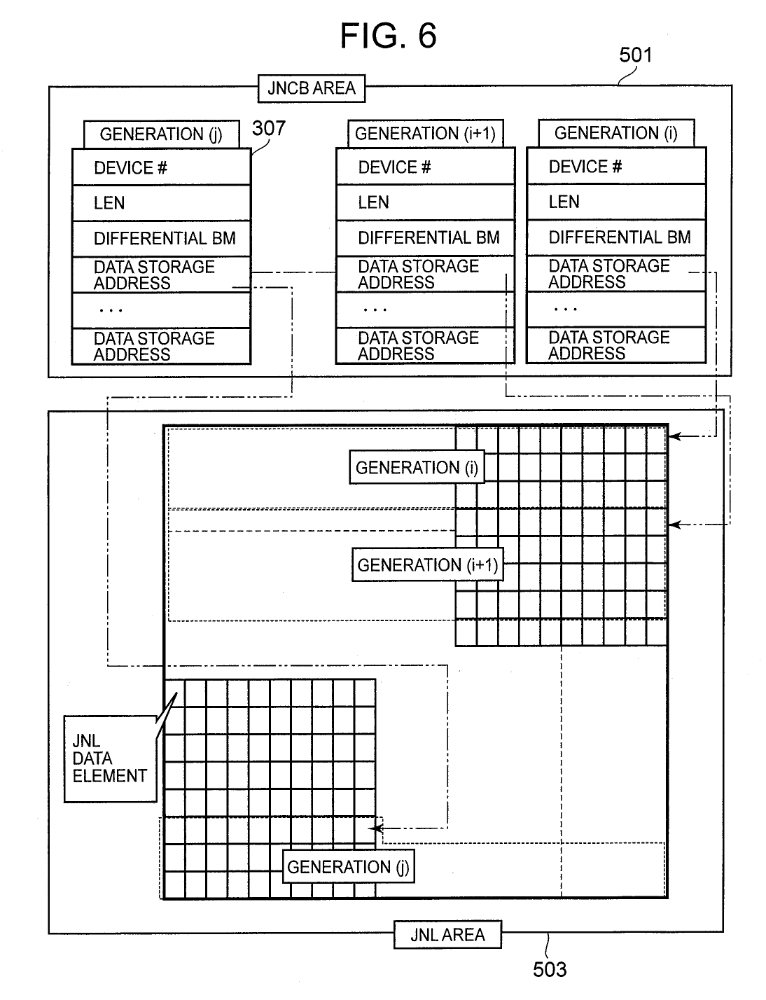

FIG. 6 shows a data management system that takes inter-generational difference data as an example from among online update difference data, inter-generational difference data and merge difference data.

As shown in FIG. 6, a plurality of JNCB corresponding to a plurality of generations is stored in the JNCB area 501, and a plurality of JNL sub-areas corresponding to this plurality of generations exists in the JNL area 503.

From the differential BM inside the JNCB 307 corresponding to a specified generation (for example, generation (i)), it is possible to learn where in the P-VOL of that generation there was an update. Further, referencing the respective data storage addresses recorded in the JNCB 307 corresponding to this generation makes it possible to learn where inside the JNL area 503 the respective data elements, which configure the inter-generational difference data corresponding to this generation, exist.

FIG. 7 shows the flow of the process for configuring the host write size.

The management server 111 issues a host write size query to the host computer 101 (Step 7001). The host write size from the host computer 101 is sent as a reply by a prescribed computer program inside the host computer 101 (a computer program that has a function for replying with a host write size in response to the above-mentioned query) being executed by the CPU 103 (Step 7002). This prescribed computer program, for example, can include a file system or a database management system (DBMS).

The management server 111 sends the replied host write size and the host identifier (or P-VOL number) corresponding to this host write size to the first storage system 125 (and the second storage system 161).

The write size management program 215 (refer to FIG. 4) specifies the respective P-VOL corresponding to the host identifier (or P-VOL number) from the management server 111, and configures the host write size from the management server 111 in the configuration management tables 201 corresponding to these respective P-VOL as the I/O size (Step 7004).

Then, the write size management program 215 executes a formatting process based on this host write size (Step 7005). In the formatting process, for example, the JNL area management table 203, backup generation management table 205, first JNL management table 207 and JNCB 307 corresponding to the above-described specified respective P-VOL are created. More specifically, for example, the size of the block that configures the P-VOL, and the size of the segment that configures the JNL area 503 are managed as being the same size as the host write size. Therefore, the number of bits configuring the differential BM inside the JNCB 307 constitutes the number of blocks obtained by the P-VOL being delimited by the host write size. Consequently, for example, the size of the online update difference data element, the size of the data element saved from the S-VOL, or the size of the data element copied from the P-VOL to the S-VOL becomes the host write size.

Furthermore, when the host write size is not configured as the I/O size, the size of the created JNL data element is the initial value of the I/O size (for example, the unit management size of the cache memory 147, or the unit management block size of the file system). Further, the write size management program 215 can also receive the host write size from the host computer 101. Further, the block size, the block size of the S-VOL that configures a pair with the P-VOL, and the segment size of the JNL sub-area related to the P-VOL may differ for each P-VOL. This is because the host write size can also differ if the host computer 101 (or operating system) that uses the P-VOL differs. More specifically, for example, the block size of the P-VOL accessed from a first type host computer is a first host write size corresponding to this first type host computer, and the block size of the P-VOL accessed from a second type host computer can constitute a second host write size, which corresponds to this second type host computer, and which differs from the first host write size.

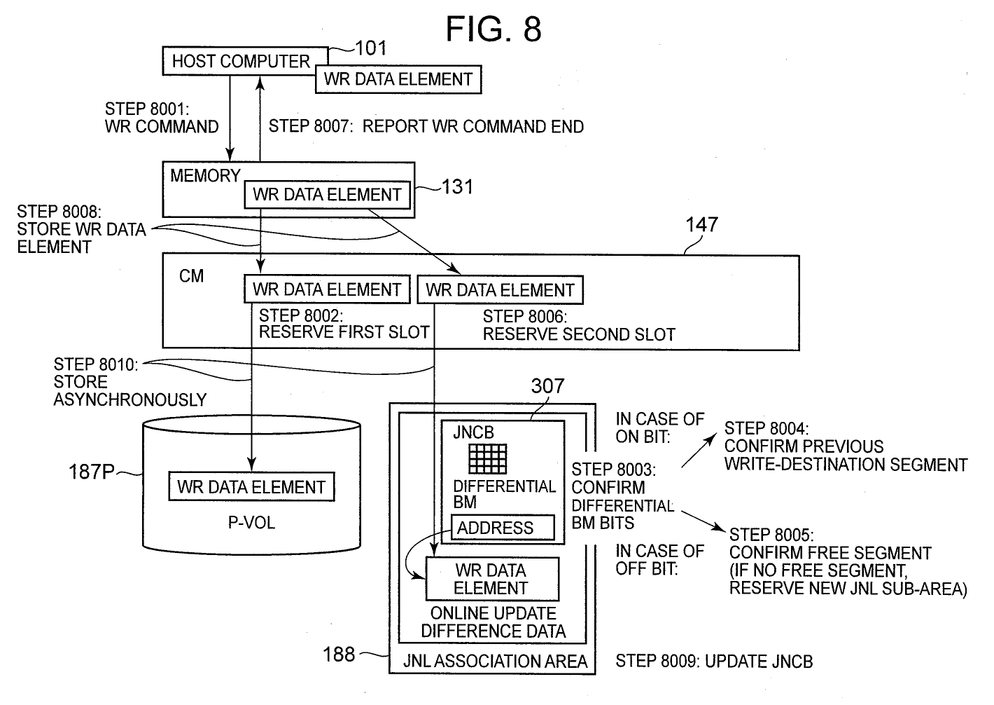

FIG. 8 shows the flow of a write process that writes a write data element to the P-VOL. Hereinafter, each P-VOL that is specified by the write command will be referred to as the “target P-VOL” in the explanation of FIG. 8. Further, in the following explanation, to prevent the explanation from becoming redundant, a target corresponding to generation K will be expressed by appending (K) after the name of this target. More specifically, for example, a JNCB corresponding to generation (j) will be expressed as “JNCB (j)”, and an S-VOL corresponding to generation (j−1) will be expressed as “S-VOL (j−1)”.

The front-end interface 127 receives a write command and write data element from the host computer 101, and stores the write data element in memory 137 (Step 8001). The write command is transferred to the processor 143.

The R/W program 213 (Refer to FIG. 4) reserves a first slot from the cache memory 147 in response to write command reception (Step 8002). Furthermore, the “slot” is the unit management area of the cache memory 147. The slot size, for example, is larger than the host write size. When the host write size has not been configured, for example, a JNL data element is created in the slot size as the initial value.

The R/W program 213 references the bit corresponding to the write-destination block specified by the write command in the differential BM (latest differential BM) that corresponds to an indefinite point in time of the target P-VOL 187P (Step 8003).

If this bit is indicated as having been updated, the R/W program 213 references the data storage address corresponding to this bit, and specifies the segment indicated by this address (Step 8004).

Conversely, if the bit referenced in Step 8003 is indicated as not having been updated, the R/W program 213 specifies a free segment inside the JNL sub-area corresponding to the online update difference data for the target P-VOL 187P by referencing the JNL area management table 203 corresponding to the target P-VOL 187P (Step 8005). Furthermore, if there is no free segment, a new JNL sub-area can be reserved.

The R/W program 213 reserves a second slot from the cache memory 147 (Step 8006).

The R/W program 213 reports the end of the write command to the host computer 101 that was the source of the write command (Step 8007). In response to this, the write data element is sent from the host computer 101 and stored in the memory 131 of the front-end interface 127.

The R/W program 213 respectively writes the write data elements stored in the memory 131 of the front-end interface 127 to the first and second slots (Step 8008).

The R/W program 213 updates the JNCB 307 corresponding to the online update difference data of the target P-VOL 187P (Step 8009). More specifically, for example, the data storage address, which corresponds to the destination segment (referred to in the explanation of FIG. 8 as the “JNL-destination segment”) in which the write data element is written as the online update difference data element, is added. Further, for example, if the write-destination block has not been updated, the bit (bit inside the differential BM) corresponding to the write-destination block is updated to ON (the value indicating updated).

The R/W program 213 writes the write data element inside the first slot to the write-destination block inside the target P-VOL 187P, and writes the write data element inside the second slot to the above-mentioned JNL-destination segment (the segment specified in either Step 8004 or 8005) (Step 8010). The write data elements inside the first and second slots can be written at the same time, or can be written at different times.

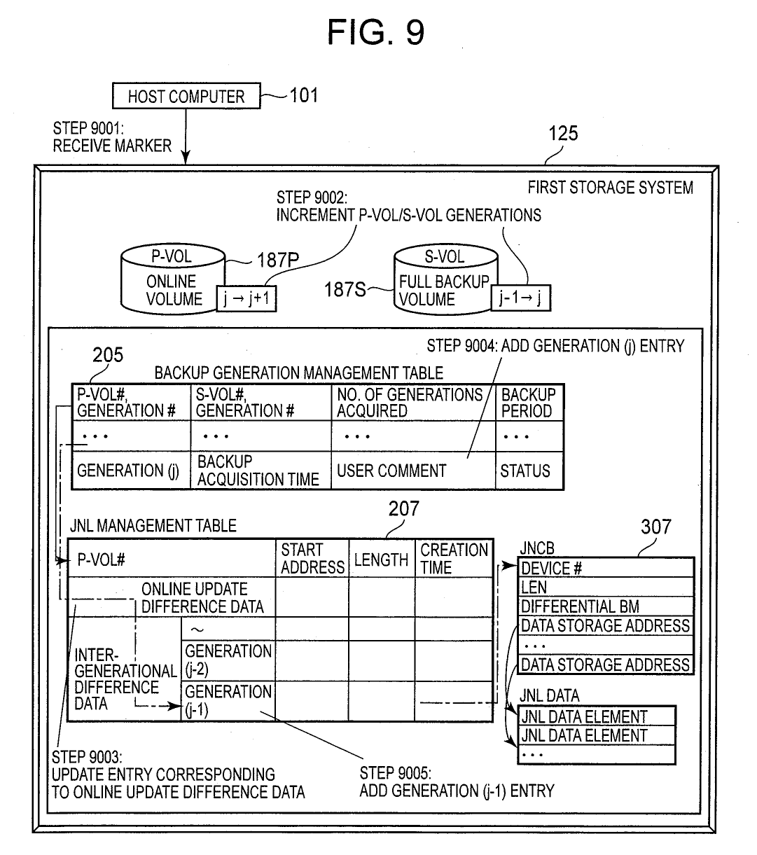

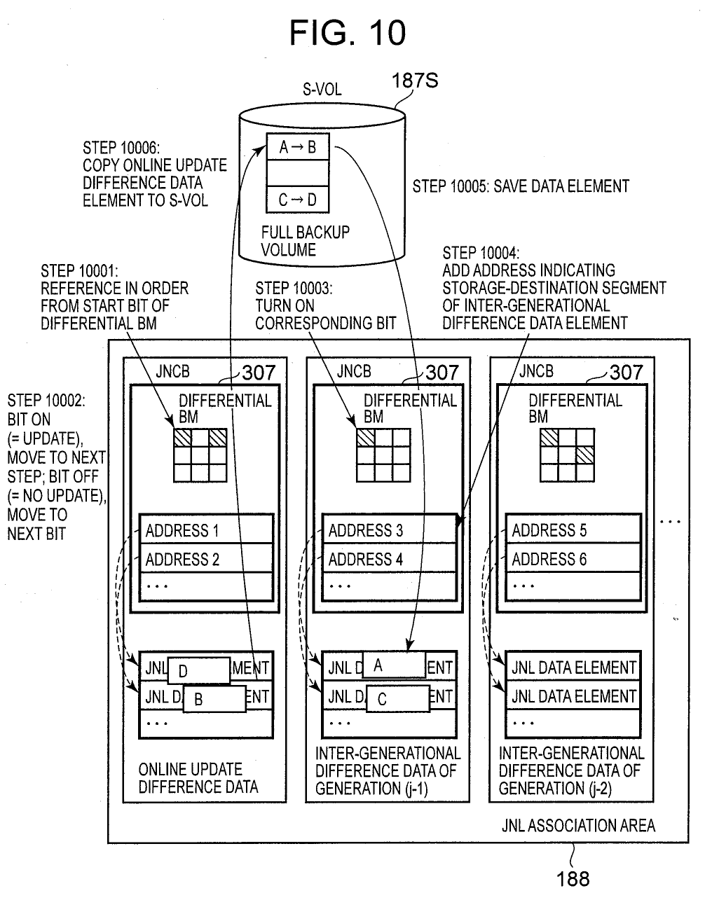

FIG. 9 shows the marker reception and the flow of processing carried out in response to marker reception. Furthermore, in the explanations of FIG. 9 and the subsequent FIG. 10, a P-VOL specified by a marker will be referred to as the “target P-VOL”, and an S-VOL that configures a pair with a target P-VOL will be referred to as the “target S-VOL”.

The front-end interface 127 receives a marker from the host computer 101 (Step 9001). The received marker is transferred to the processor 143.

The marker processing program 223 respectively increments by 1 the generations of the target P-VOL 187P and the target S-VOL 187S in response to receiving the marker (Step 9002). For example, the generation of the target P-VOL 187P is updated from j to j+1, and the generation of the target S-VOL 187S is updated from j−1 to j. More specifically, for example, the respective generation # of the target P-VOL and target S-VOL are updated in the backup generation management table 205. That is, generation (j) of the target P-VOL 187P is defined, and generation (j+1) is the undefined generation.

The marker processing program 223 adds the “start address”, “length” and “creation time” corresponding to the online update difference data (j+1) to the first JNL management table 207 (Step 9003). That is, a JNL sub-area in which the online update difference data (j+1) is to be stored is prepared. Consequently, the online update difference data (j) of the marker reception value need not be overwritten by the online update difference data (j+1).

The marker processing program 223 adds the defined generation (j) row to the backup generation management table 205, and registers the backup acquisition time (marker reception time) and a user comment received at the same time as marker reception in this row (Step 9004).

The marker processing program 223 adds a generation (j−1) row for the inter-generational difference data to the first JNL management table 207 (Step 9005). At this time, JNCB (j−1) is created based on the “I/O size” (that is, the host write size) of the S-VOL (more specifically, for example, the number of bits configuring the differential BM (j−1) is used as the number of blocks for this “I/O size”). The start location of JNCB (j−1) is written in the added row as the “start address”. JNCB (j−1) is updated on the basis of the sort process. This sort processing will be explained by referring to FIG. 10.

FIG. 10 shows the flow of the sort process. Furthermore, the online update difference data and the differential BM corresponding thereto shown in FIG. 10 correspond to generation (j).

In response to marker reception, the JNL sort program 217 (refer to FIG. 4) boots up. The JNL sort program 217 executes the sort process using the flow of processing shown in FIG. 10.

That is, the JNL sort program 217 references the bits of the differential BM (j) corresponding to the target P-VOL 187P sequentially from the start bit (Step 10001). If the referenced bit is ON (if this bit is indicated as having been updated), Step 10003 is carried out for this bit, and if the referenced bit is OFF (if this bit is indicated as not having been updated), the subsequent bit is referenced (Step 10002).

The JNL sort program 217 turns ON the bit in differential BM (j−1) that corresponds to the ON bit in differential BM (j) (Step 10003).

The JNL sort program 217 adds the data storage address corresponding to the bit that was turned ON in Step 10003 to the inside of JNCB (j−1) (Step 10004). This data storage address indicates the save-destination segment (the segment inside the JNL sub-area (j−1)) of Step 10005. This save-destination segment is the segment subsequent to the save-destination segment of the immediately previous time. Consequently, the respected data elements saved from the target S-VOL (j) are written to contiguous segments inside the JNL sub-area (j−1).

The JNL sort program 217 saves the data element “A” that is stored in the block (the block inside target S-VOL 187S) corresponding to the bit that is ON in differential BM (j−1) from this block to the above-mentioned save-destination segment (Step 10005).

The JNL sort program 217 writes data element “B”, which is stored in the segment (the segment inside JNL sub-area (j)) indicating the data storage address corresponding to the ON bit in differential BM (j), to the save-source block (the block inside target S-VOL (j)) (Step 10006).

According to the above Steps 10005 and 10006, a COW resulting from the online update difference data element “B” being written to a block inside the target S-VOL (j), saves data element “A”, which is stored in this block, to the segment inside JNL sub-area (j−1), and the online update difference data element “B” is written to the block inside the target S-VOL (j).

As described hereinabove, the bits configuring differential BM (j) are referenced in block address order, and each time an ON bit is detected, JNL data elements are sorted by Steps 10003 through 10006 being carried out. That is, the online update difference data elements, which had been chronologically contiguous in JNL sub-area (j), are reflected in the target S-VOL in block address order, thereby resulting in contiguous inter-generational difference data elements in block address order in JNL sub-area (j−1).

Furthermore, after the above sort processing has ended, all of the bits configuring the differential BM corresponding to the online update difference data are turned OFF (each time an online update difference data element is written to the S-VOL, the bit corresponding to this data element can be turned OFF).

FIG. 11 is the flow of merge processing for inter-generational difference data. FIG. 12 shows the movement of data elements related to this merge processing. Merge processing will be explained hereinbelow by referring to FIGS. 11 and 12.

As shown in FIG. 12, the JNL merge program 219 (refer to FIG. 4) commences merge processing, which converts (m+1) generations' worth of inter-generational difference data to merge difference data when the accumulation of a certain number of generations' worth of inter-generational difference data (for example, (m+1) generations (generation (N) through generation (N+m)) is detected. Furthermore, treating the detection of (m+1) generations' worth of inter-generational data as the trigger for commencing a merge process is only one example, and other triggers, for example, the passage of a prescribed period of time since the immediately previous merge process, are also possible.

The JNL merge program 219 sets the “status” of the merge-targeted generation (N) through generation (N+m) to “merging” in the backup generation management table 205. Then, the JNL merge program 219 selects as a target the inter-generational difference data of the oldest merge-targeted generation (N) (Step 11001).

The JNL merge program 219 decides the start bit of the differential BM (N) corresponding to the targeted inter-generational difference data as the reference location (Step 11002).

The JNL merge program 219 executes Step 11004 if the bit treated as the reference location for differential BM (N) is ON, and executes Step 11009 if this bit is OFF. In the explanations of FIGS. 11 and 12 below, the bit treated as this reference location will be referred to as the “target bit”, and if this bit is ON, will be referred to as the “target ON bit”, and if this bit is OFF, will be referred to as the “target OFF bit”.

The JNL merge program 219 executes Step 11005 for the differential BM corresponding to recently created merge difference data (hereinafter referred to as the “merge differential BM” in the explanations of FIGS. 11 and 12) if the bit, which is in the same location as the above-mentioned target bit, is OFF, and executes Step 11009 if this bit is ON.

JNL merge program 219 searches for the data storage address corresponding to the target ON bit of the differential BM (N) (Step 11005), and specifies this address (Step 11006). Then, the JNL merge program 219 copies the inter-generational difference data element stored in the segment indicated by this address to the segment inside the JNL sub-area corresponding to the merge difference data to be created this time (the segment subsequent to the copy-destination segment of the immediately previous time) (Step 11007). Then, the JNL merge program 219 turns ON the bit that is in the same location as the above-mentioned target bit in the merge differential BM (Step 11008).

The JNL merge program 219 treats the subsequent bit as the reference location if there is a bit in the location subsequent of the reference location that has not been referenced yet in the differential BM (N) (Step 11009: YES), sets the subsequent bit as the reference location (Step 11010), and executes Step 11003. If there is no unreferenced bit in the subsequent location (Step 11009: NO), the processing for this generation (N) is ended (Step 11011), and if there is a subsequent generation (Step 11012: YES), Step 11001 is carried out for the subsequent generation (N+1). If there is no subsequent generation (that is, if the generation processed immediately prior is (N+m)) (Step 11012: NO), merge processing ends.

According to the flow of processing described hereinabove, as shown in FIG. 12, processing is first carried out from the inter-generational difference data corresponding to the oldest generation of the merge-targeted generations (N) through (N+m). If there is an ON bit in the differential BM corresponding to the inter-generational difference data, and the bit corresponding to this bit is OFF, the inter-generational difference data element corresponding to this ON bit is copied to the JNL sub-area corresponding to the merge difference data. Conversely, if there is an ON bit in the differential BM corresponding to the inter-generational difference data, and the bit corresponding to this ON bit is ON in the merge differential BM as well, the data element corresponding to the ON bit inside the differential BM corresponding to the inter-generational difference data is not copied.

In other words, the inter-generational difference data element corresponding to the older generation is preferentially copied to the JNL sub-area corresponding to the merge difference data. More specifically, for example, according to FIG. 12, inter-generational difference data elements “A” and “G”, which correspond to the start blocks of the P-VOL, exist for two generations, generation (N) and generation (N+m). In this case, as described hereinabove, since the inter-generational difference data element corresponding to the older generation is given priority, the data element “A” of generation (N) is copied to the JNL sub-area corresponding to the merge difference data, but data element “G” of the generation that is newer than this generation (N) is not copied to this JNL sub-area.

Furthermore, in this merge process, processing starts from the old generation first, but processing can also start from a new generation first. However, in this case, if there is an ON bit in the differential BM corresponding to the inter-generational difference data, and the bit corresponding to this ON bit is ON in the merge differential BM as well, the data element that corresponds to the ON bit inside the differential BM corresponding to the inter-generational difference data can be overwritten by the merge difference data element corresponding to the ON bit, which is stored in the JNL sub-area corresponding to the merge difference data. Further, when the merge difference data is created, the plurality of generations' worth of inter-generational difference data that constitutes the basis of this merge difference data can be deleted either immediately after the end of merge difference data creation, or in response to an indication from a computer (for example, either the host computer 101 or the management server 111).

Further, inter-generational difference data and merge difference data can also be deleted from an old generation. In this case, for example, a JNL delete program not shown in the figure releases the JNCB and JNL data corresponding to the delete-targeted generation, and manages the deleted generation as a free area. Further, the JNL delete program deletes entries corresponding to the delete-targeted generation from the first JNL management table 207 and the backup generation management table 205.

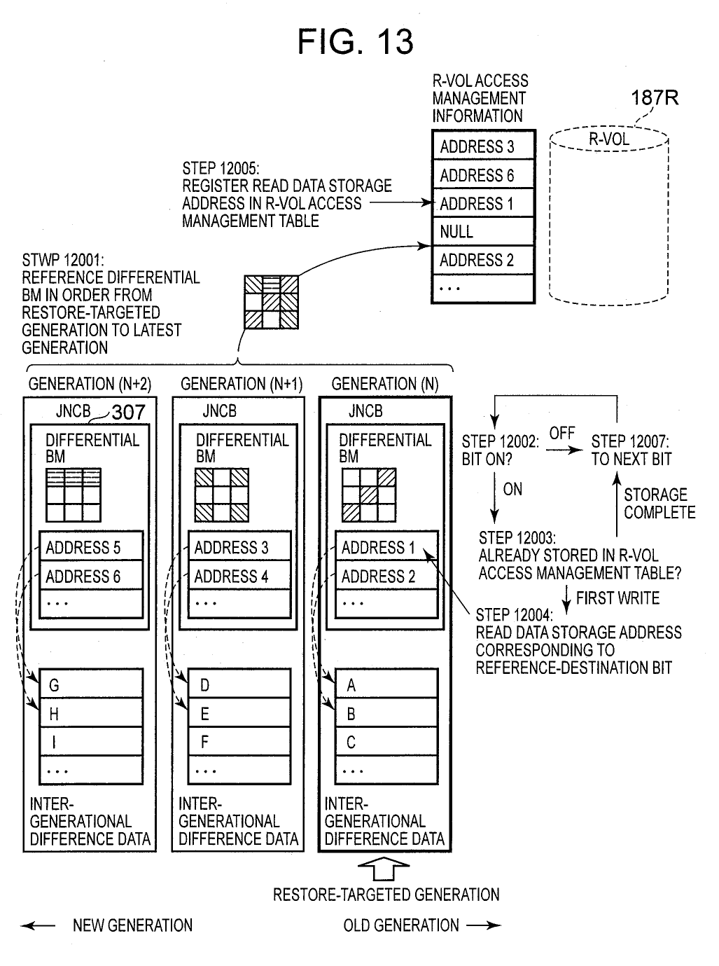

FIG. 13 shows the flow of a restore process.

The restore program 221 (Refer to FIG. 4) receives a restore request having a restore-targeted generation specified by the user from either the host computer 101 or the management server 111. More specifically, for example, the restore program 221 sends the information of the backup generation management table 205 and so forth to either the host computer 101 or the management server 111 in response to a request from either the host computer 101 or the management server 111. The user references the “generation #”, “backup acquisition time” and “user comment” in this table 205 and so forth, decides the restore-targeted generation, and specifies the decided restore-targeted generation to either the host computer 101 or the management server 111. The restore request having this specified restore-targeted generation (N) is sent to the restore program 221 from either the host computer 101 or the management server 111.

The restore program 221 executes the restore process in response to the restore request. In the restore process, the R-VOL access management table 209 is created. The R-VOL access management table 209 is configured from a plurality of address records. The respective address records correspond to the respective blocks (virtual blocks) that configure the R-VOL, and as such, correspond to the respective bits in the differential BM.

The restore program 221 sequentially references the differential BM of the inter-generational difference data (or the merge difference data) from the restore-targeted generation (N) to the new generations (N+1), (N+2) (Step 12001). A case in which the reference-destination differential BM is the restore-targeted generation (N) will be given as an example and explained hereinbelow.

The restore program 221 carries out ON-OFF determinations from the start bit of the differential BM (N) (Step 12002). When the referenced bit is ON, the restore program 221 references the address record corresponding to this ON bit (Step 12003). If an invalid address (for example, Null) is in this record, the restore program 221 reads out the data storage address corresponding to the referenced ON bit from inside JNCB (N) (Step 12004), and registers this record (Step 12005), and conversely, if a valid address has been registered in this record, references the subsequent bit (Step 12006).

The R-VOL access management table 209 is completed by carrying out the above Steps 12002 through 12006 for not only the restore-targeted generation (N), but also for the newer generations (N+1) and (N+2). That is, for example, in Step 12006, if there is no subsequent bit to serve as the reference destination, Steps 12002 through 12006 are carried out for the generation (N+1) subsequent to the restore-targeted generation (N).

When the R-VOL access management table 209 is created as described hereinabove, a read process (and write process) to the R-VOL is possible. In this case, the “status” corresponding to the R-VOL in the configuration management table 201 becomes “normal” (that is, R/W enabled) (prior to this, this “status” is “R/W disabled”).

Incidentally, instead of creating an R-VOL access management table 209, an R-VOL can be provided as a real VOL. In this case, for example, the data storage address is specified using the same method as the method for creating the R-VOL access management table 209, and the data element can be copied from the segment indicated by the specified address to the block that corresponds to the bit to which this address corresponds inside the R-VOL (real VOL).

FIG. 14 shows the flow of a read process that uses the R-VOL access management table 209.

The R/W program 213 (refer to FIG. 4) receives from the host computer 101 a read command that specifies the R-VOL 187R shown in FIG. 13 (Step 14001).

The R/W program 213 references the record (the record inside the R-VOL access management table 209) corresponding to the read-source block-specified by this read command (Step 14002).

If the result of Step 14002 is that a valid address is registered in the reference-destination record, the R/W program 213 reads out the data element from the segment indicated by this address, and sends this data element to the host computer 101 (Step 14003).

Conversely, if the result of Step 14003 is that an invalid address is registered in the reference-destination record, the R/W program 213 reads out the data element from the block that has the same address as the above-mentioned read-source block inside the S-VOL (full backup volume) corresponding to the R-VOL, and sends this data element to the host computer 101 (Step 14004).

FIG. 15 shows the flow of a write process that uses the R-VOL management table 209.

The R/W program 213 receives from the host computer 101 a write command that specifies the R-VOL 187R shown in FIG. 13 (Step 15001). The R/W program 213 references the record (the record inside the R-VOL access management table 209) corresponding to the write-destination block specified in this write command.

If the valid address “address 3” is registered in the reference-destination record, the R/W program 213 reserves an area the size of the host write size from either storage pool 189A or 189B (Step 15002), and changes the above-mentioned valid address “address 3” to “address P1”, the address indicating this reserved area (Step 15003). Then, the R/W program 213 writes the write data element to this reserved area (Step 15004).

Furthermore, if an invalid address is registered in the reference-destination record, this invalid address is changed to the address indicating the reserved area inside either storage pool 189A or 189B.

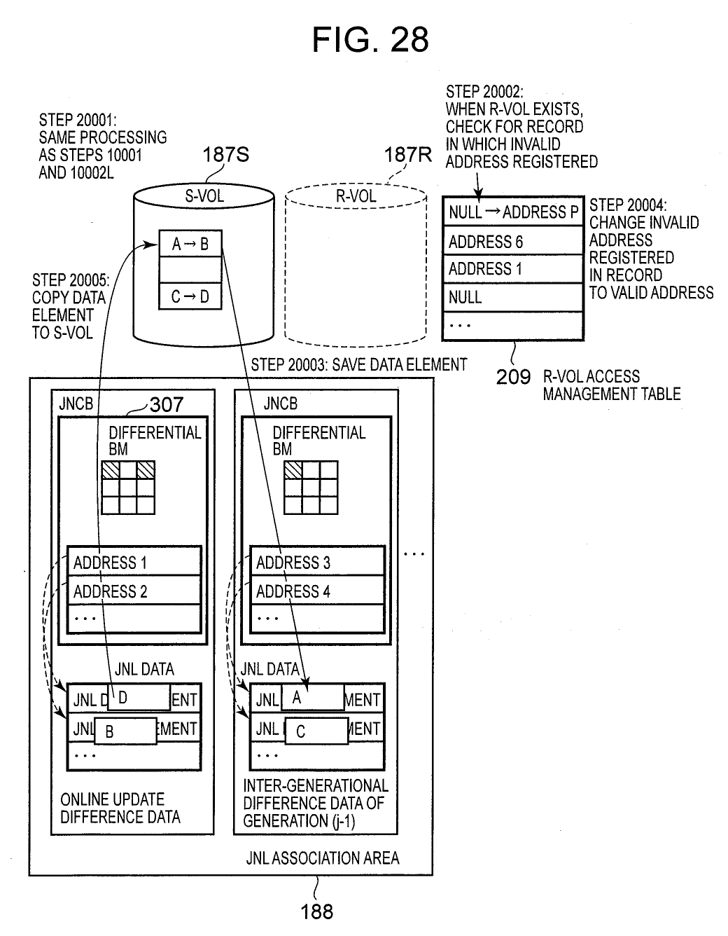

FIG. 28 shows the flow of sort processing when there is an R-VOL.

Copying online update difference data to the S-VOL when a marker is received saves the data element that was stored in the S-VOL. Thus, when a marker is received in a state in which there is an R-VOL, there is the danger of the corresponding relationships between the respective addresses and the respective data elements stored in the R-VOL access management table changing. More specifically, for example, due to the fact that an invalid address is registered in the reference-destination record of the R-VOL access management table, a read of the data element stored in the block (a block inside the S-VOL) corresponding to this reference-destination record can be expected, but if the online update difference data element is copied to this block as a result of the above-mentioned marker reception, this data element will be saved to the JNL sub-area, making it impossible to acquire the expected data element from the S-VOL.

For this reason, the processing to be explained by referring to FIG. 28 is carried out.

First, Steps 10001 through 10002 are carried out (Step 20001).

Next, the JNL sort program 217 determines whether or not the corresponding S-VOL will be accessed when the R-VOL is accessed (Step 20002). More specifically, the JNL sort program 217 determines whether or not an invalid address is registered in the R-VOL access management table 209.

If the result of this determination is that an invalid address is discovered, the JNL sort program 217 specifies the block corresponding to the record in which the invalid address is registered, and references “address 3”, which is the data element address (the data storage address corresponding to the bit inside differential BM (j−1)) corresponding to the specified block. Then, the JNL sort program 217 saves data element “A”, which is stored in the block (the block inside the S-VOL) corresponding to the record in which this invalid address is registered, to the segment indicated by this address “address 3” (Step 20003). The JNL sort program 217 changes the invalid address “Null” to the address “address P1” indicating the save-destination segment of data element “A” in the R-VOL access management table 209 (Step 20004). Then, the JNL sort program 217 writes online update difference data element “B”, which corresponds to this block, to the save-source block (Step 20005).

In accordance with the processing described hereinabove, a sort process that maintains the corresponding relationships between the respective blocks and the respective data elements inside the R-VOL can be carried out even when a marker is received when there is an R-VOL.

### Embodiment 2

A second embodiment of the present invention will be explained hereinbelow. In so doing, explanations of the points in common with the first embodiment will be simplified or omitted, and the explanation will focus mainly on the points of difference with the first embodiment.

This embodiment achieves a further reduction in the amount of backup data via a computer program that is executed on a host computer 101 and a management server 1111.

### <(1) Configuration of Computer System Related to Second Embodiment>

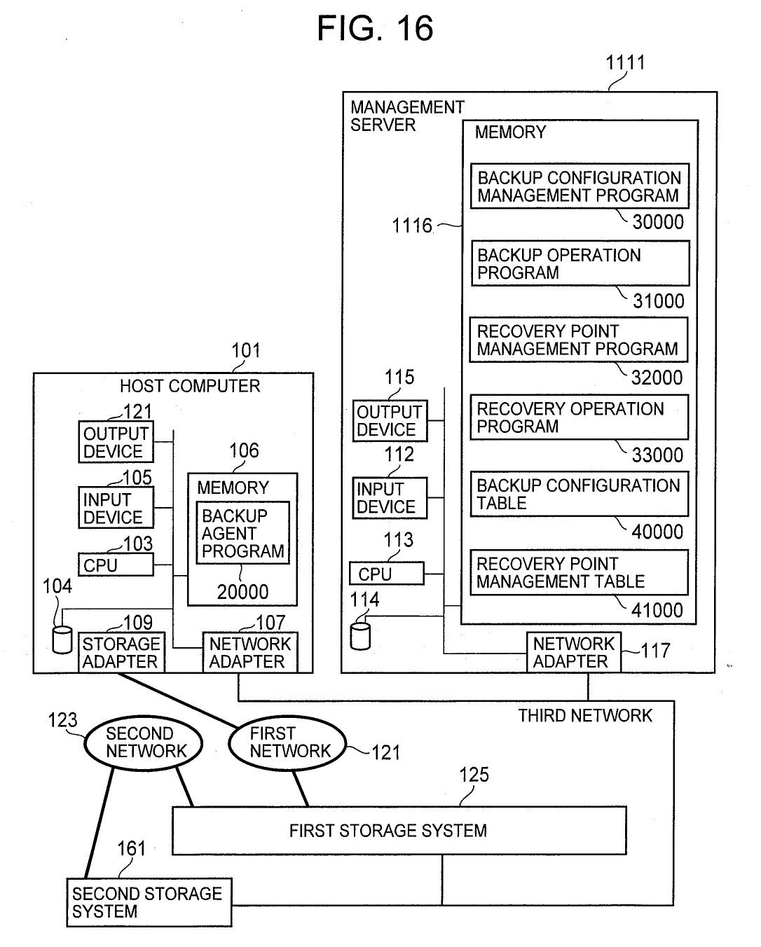

FIG. 16 shows the configuration of a computer system related to the second embodiment of the present invention.

A backup agent program 20000 is stored in a memory 106 of the host computer 101. The backup agent program 20000 is executed by a CPU 103 inside the host computer 101.

A backup configuration management program 30000, backup operation program 31000, recovery point management program 32000, recovery operation program 33000, backup configuration table 40000, and recovery point management table 41000 are stored in a memory 1116 of the management server 1111. The respective program processes and table structures will be explained further below.

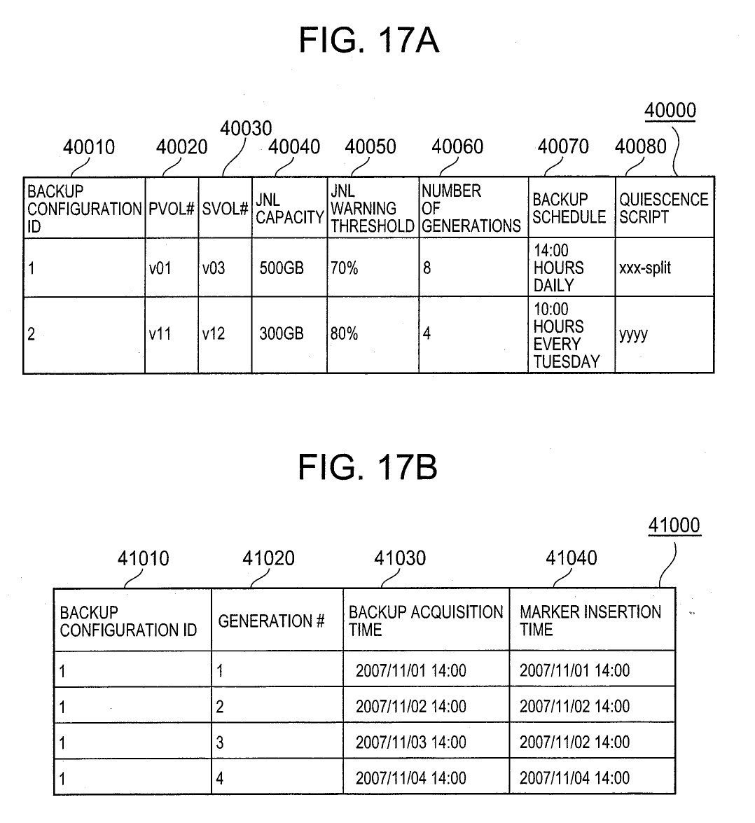

FIG. 17A is an example of the backup configuration table 40000.

Information related to a backup configuration is recorded in this table 40000. This table 40000 comprises the following fields:

(17A-1) a field 40010 in which a backup configuration ID for uniquely identifying a backup configuration is registered;
(17A-2) a field 40020 in which the number (P-VOL#) of the P-VOL (P-VOL in the first storage system) of a backup configuration is registered;
(17A-3) a field 40030 in which the number (S-VOL#) of the S-VOL (S-VOL in the first storage system) of a backup configuration is registered;
(17A-4) a field 40040 in which the JNL capacity of a backup configuration is registered;
(17A-5) a field 40050 in which a threshold value of the JNL capacity of a backup configuration is registered;
(17A-6) a field 40060 in which the number of snapshot generations acquired for a backup configuration is registered;
(17A-7) a field 40070 in which information denoting a schedule for inserting a marker to create a snapshot in a backup operation, which will be described hereinbelow, is registered; and
(17A-8) a field 40080 in which script information (or command information) that is executed to quiet a host computer file system or application for creating a snapshot in a backup operation, which will be described hereinbelow, is registered. That is, a backup configuration ID, P-VOL#, S-VOL#, JNL capacity, JNL warning threshold, number of generations, backup schedule, and quiescence script are registered in this table 40000 for each backup configuration. The method of using this table 40000 will be explained hereinbelow.

The reason for quieting the file system or application when creating a snapshot will be explained here. For example, the cause of a computer system shutdown could conceivably be a failure of a software program, such as a database management system (not shown in the figure; abbreviated as DBMS hereinbelow), an application other than a DBMS (not shown in the figure; abbreviated hereinbelow as non-DB app), or a file system (not shown in the figure; abbreviated as FS hereinbelow) that are running on the host computer. Data capable of being restored using this embodiment is not necessarily useful in a backup operation in preparation for a failure. This is because a DBMS or FS use the memory 3106 of the host computer 101 as a data buffer, and as such, when data that has been written to a P-VOL is being processed by the DBMS or a non-DB app, data inconsistencies occur when this data is restored in an attempt to resume operations. Accordingly, in an actual backup operation, data in the memory 106 of the host computer 101 that is being used as a data buffer by a DBMS or FS is forcibly outputted to a P-VOL. This is called “application quiescence”. Most DBMS and FS are provided with a command or script for quieting an application. If a snapshot is created at the time of this quiescence, a restore is possible without data inconsistencies occurring. Accordingly, in this embodiment, snapshot creation is carried out at the time of this application quiescence.

FIG. 17B is a diagram of the configuration of a recovery point management table 41000.

This table 41000 is for managing the snapshot generations of the respective backup configurations. This table 41000 comprises the following fields:

(17B-1) a field 41010 in which a backup configuration ID for uniquely identifying a backup configuration is registered;
(17B-2) a field 41020 in which a generation # for uniquely identifying a snapshot is registered;
(17B-3) a field 41030 in which data denoting the time (backup acquisition time) at which snapshot creation based on a backup schedule was executed by a backup operation, which will be explained hereinbelow, is registered; and
(17B-4) a field 41040 in which information denoting a marker insertion time when a snapshot was created by a backup operation on the basis of a backup schedule is registered. That is, a backup configuration ID, generation #, backup acquisition time and marker insertion time are registered for each backup configuration and generation in this table 41000. The method of using this table 41000 will be explained hereinbelow.

The preceding has been an explanation of the configuration of a computer system of the second embodiment.

### <(2) Backup Configuration Management Process>

Next, the backup configuration management process will be explained.

Backup configuration management processing is realized in accordance with the backup configuration management program 30000 inside the management server 1111, and the backup agent program 20000 inside the host computer 101.

The backup configuration management program 30000 registers either an administrator-configured P-VOL (a P-VOL inside the first storage system 125) or a logical volume on the host computer 101 (a volume created by a P-VOL inside the first storage system 125 being mounted) in the table 40000 as a backup configuration, and carries out a backup operation. Further, the processing flow of the backup agent program 20000 is not shown in the figure, but this program 20000 receives an indication from the backup configuration management program 30000, and acquires the corresponding relationship between a logical volume managed by the host computer 101 and a P-VOL inside the first storage system 125.

The processing flows of the programs will be shown below. Furthermore, unless otherwise specified, it is supposed that the steps of the respective programs are executed by either CPU 113 or 103 of either the management server 1111 or the host computer 101.

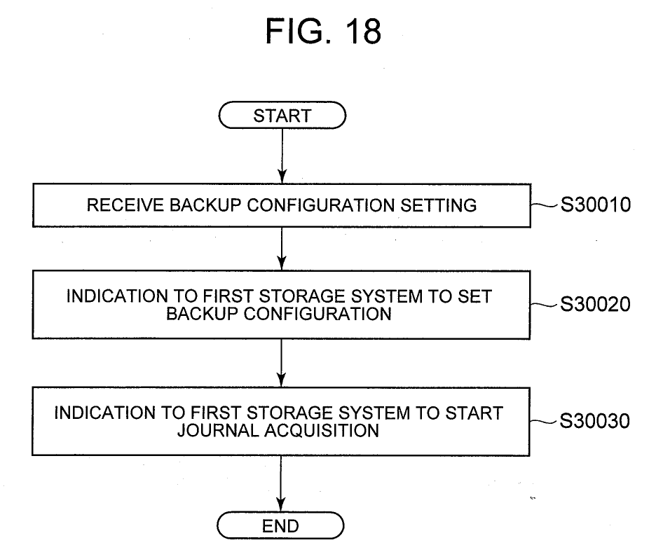

FIG. 18 shows the flow of processing of the backup configuration management program 30000.

The backup configuration management program 30000 displays a backup configuration management screen, for example, on an output device 115 of the management server 1111, and receives backup configuration settings from an administrator (Step S30010). An example of a backup configuration screen will be explained hereinbelow. Specifically, in order to create a new entry for the backup configuration table 40000, a P-VOL #, JNL capacity, JNL warning threshold, number of generations, backup schedule, and quiescence script information can be acquired. The method for specifying a P-VOL # here can be either the direct specification of the number of a P-VOL inside the first storage system 125, or the inputting of information denoting the ID of the host computer 101 and a set of logical volumes inside the host computer 101 (hereinafter, the host/volume set). In the case of a host/volume set, the backup configuration management program 30000 can acquire the number of the P-VOL corresponding to this logical volume through the backup agent program 20000 by having the backup agent program 20000 issue an inquiry command to this logical volume. Further, the method for specifying the JNL capacity can be to either specify the capacity (for example, 300 GB) itself, or to treat the product of the specified number of generations and the P-VOL storage capacity as the specified value of the JNL capacity. The P-VOL # and number of generations are required specification parameters. For values other than these, values pre-determined by the backup configuration management program 30000 (so-called initial values) can be used.

Next, the backup configuration management program 30000 sends an indication to the first storage system 125 via the maintenance management terminal 153 of the first storage system 125 (refer to FIG. 1) to create a configuration management table 201 (Refer to FIG. 5) and a JNL area management table 203 (refer to FIG. 5) based on the values acquired in Step S30010 (Step S30020). Specifically, for example, the backup configuration management program 30000 issues a command to register the P-VOL # acquired in Step S30010, a command to create a target device that corresponds to an S-VOL from an unused storage area inside the first storage system 125, a command to register this target device as S-VOL information, and a command to create a JNL area management table 203 based on the JNL capacity acquired in Step S30010.

Finally, the backup configuration management program 30000 communicates with the first storage system's maintenance management terminal 153, boots up the R/W program 213 for the P-VOL (Refer to FIG. 4) and commences journal acquisition (Step S30030). Specifically, for example, a journal acquisition start command can be issued.

Furthermore, as the method for communicating with the first storage system 125, either instead of or in addition to sending a command to the maintenance management terminal 153, a command can also be issued to the P-VOL via the host computer 101. In this case, the backup configuration management program 30000 communicates with the backup agent program 20000, and indicates the issuing of a command to the P-VOL. Thus, the method for issuing a command to the P-VOL is advantageous in that even if communications with the maintenance management terminal 153 via the third network 108 should fail, it is possible to issue an indication to the first storage system 125 by way of the first network 156.

The preceding has been an explanation of the processing flow for the backup configuration management program 30000.

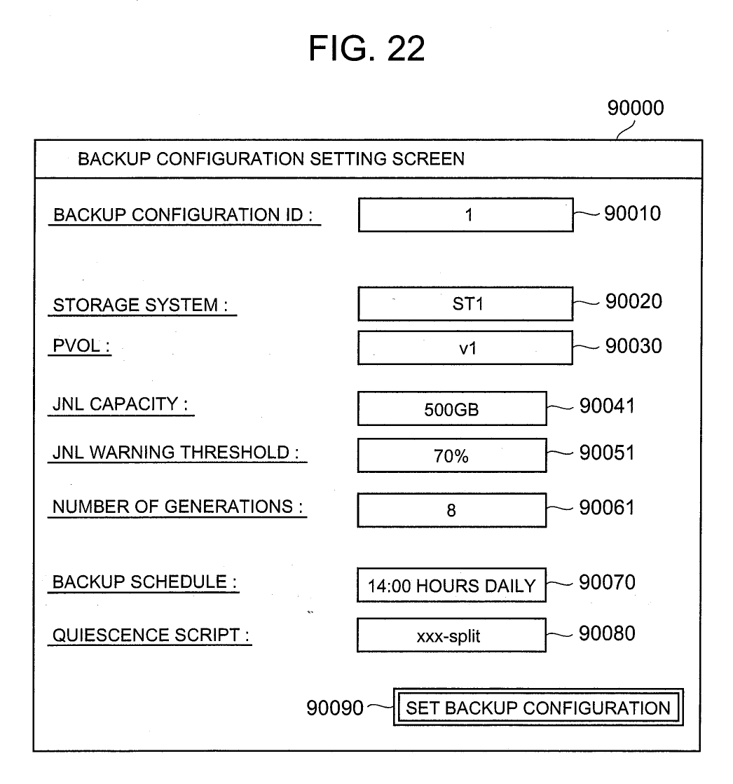

Next, an example of the screen displayed in Step S30010 will be explained by referring to FIG. 22.

When the administrator boots up the backup configuration management program of the management server, a backup configuration setting screen 90000 like that shown in FIG. 22 is displayed in Step S30010. The administrator can use this setting screen 90000 to set a backup configuration. Specifically, this setting screen 90000 has an input field 90010 for a backup ID; an input field 90020 for a storage system ID; an input field 90030 for the P-VOL #; an input field 90040 for JNL capacity; an input field 90050 for a JNL warning threshold; an input field 90050 for the number of generations; an input field 90070 for a backup schedule; an input field 90080 for quiescence script information; and a button 90090 for accepting a backup configuration.

As stated above, the P-VOL # and number of generations are required specification parameters. For the other values, pre-determined initial values can be used. Inputting at least the P-VOL # and number of generations and pressing the button 90090 will end Step S30010.

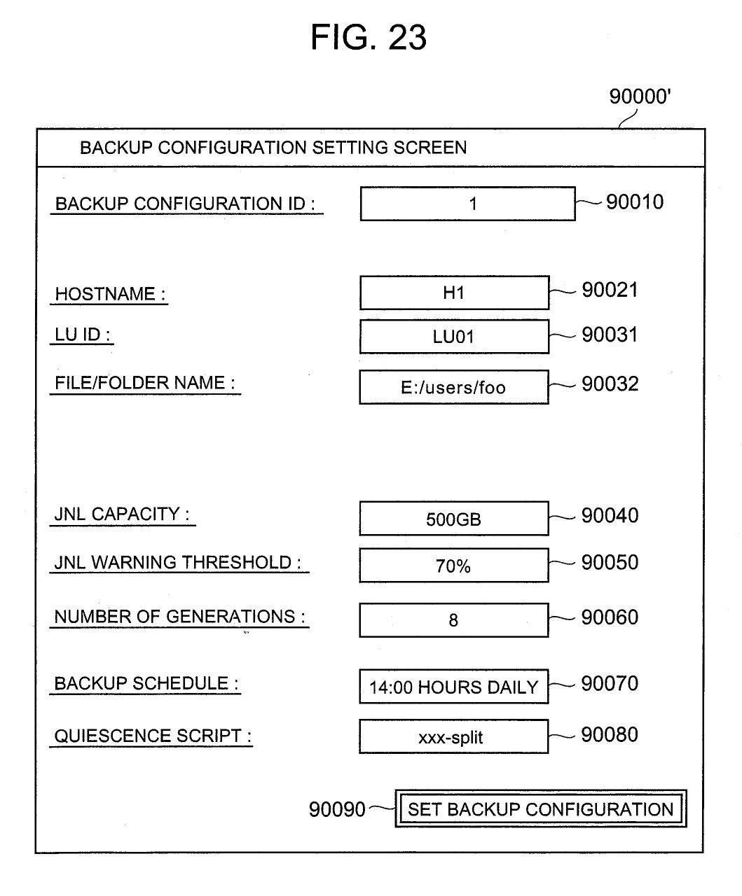

Furthermore, as shown in FIG. 23, instead of the P-VOL # input field 92030, a set comprising the hostname input field 90021 and an LU ID input field 90031 for inputting a host logical volume can be used.

Further, although the utilization method will be explained further below, as shown in FIG. 23, an input field 90032 for a backup protection-targeted filename and/or folder name can be provided in a setting screen 90000′. When a filename and/or folder name is inputted to this field 90032, the file and/or folder having this name will be targeted for backup protection.

The preceding has been an explanation of the backup configuration management process. According to this process, the administrator can define a backup configuration without inputting all the information that should be registered in the configuration management table 201 and JNL area management table 203, in other words, by just specifying at least the P-VOL # and number of generations. Further, even an administrator who is not knowledgeable of the devices of the first storage system 125 can define a backup configuration by specifying a hostname and an LU ID. This is because it becomes unnecessary to input the P-VOL #.

### <(3) Backup Operation Process>

Next, a backup operation process of this embodiment will be explained.

Backup operation processing is realized in accordance with the backup operation program 31000 inside the management server 1111 and the backup agent program 20000 inside the host computer 101.

The backup operation program 31000 quiets an application and boots up the marker processing program 223 (Refer to FIG. 4) for the first storage system 125 relative to the backup configuration defined in the backup configuration management process and in accordance with the defined backup schedule. Further, although the processing flow is not shown in the figure, the backup agent program 20000 receives an indication from the backup operation program 31000 and executes an application quiescence script inside the host computer 101. The processing flows of the programs will be described below.

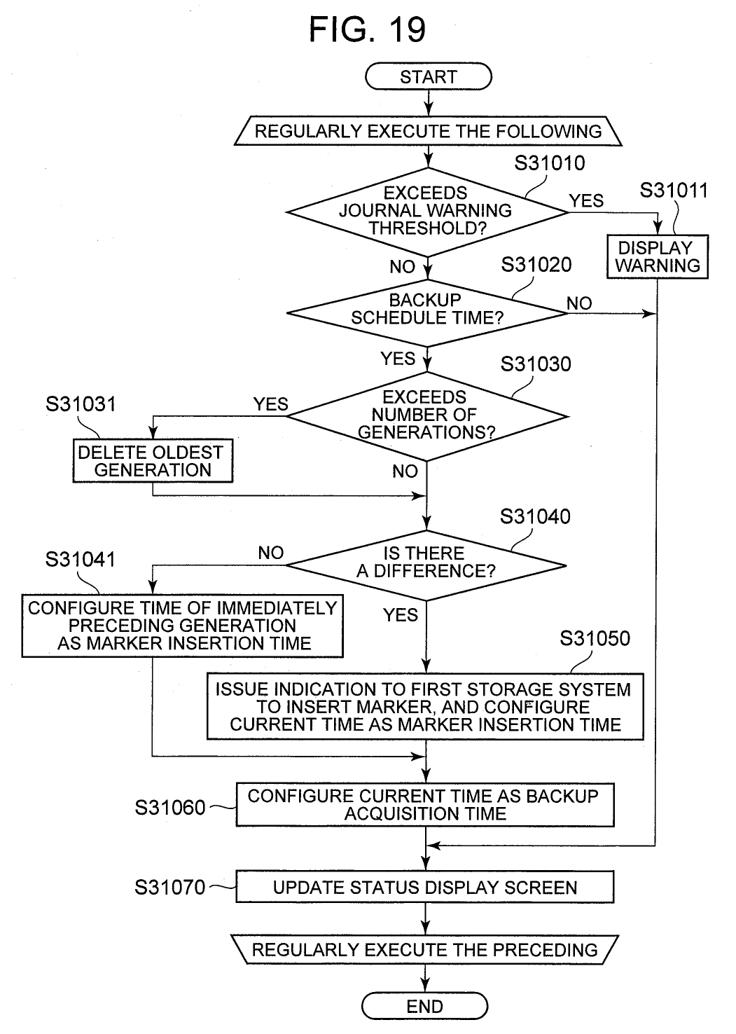

FIG. 19 shows the processing flow of the backup operation program 31000.

The backup operation program 31000 regularly executes the processing from Step S31010 to Step S31060, which will be explained further below (hereinafter referred to as regular processing in the explanation of FIG. 19), at a pre-determined time interval (for example, every five minutes). This time interval can either be defined by the administrator, or can be the backup operation program default. In the below explanation of FIG. 19, a backup configuration that is targeted for processing will be called the “target backup configuration”.

The backup operation program 31000 determines whether or not JNL usage in the target backup configuration exceeds the JNL warning threshold for the target backup configuration (hereinafter, will be called the “target JNL warning threshold” in the explanation of FIG. 19) (Step S31010). Specifically, for example, the backup operation program 31000 computes the ratio of Sum1 to Sum2, and determines whether or not the computer ratio exceeds the target JNL warning threshold. “Sum1” here is the total value of three types of JNL capacities (JNL capacity for online update difference data, JNL capacity for inter-generational difference data; and JNL capacity for merge difference data) specified from the JNL area management table 203 using the P-VOL # for the target backup configuration (hereinafter, called the target P-VOL # in the explanation of FIG. 19). “Sum2” is the total value of three types of utilization capacities (JNL utilization capacity for online update difference data, JNL utilization capacity for inter-generational difference data; and JNL utilization capacity for merge difference data) specified from the first JNL management table 207 using the target P-VOL #.

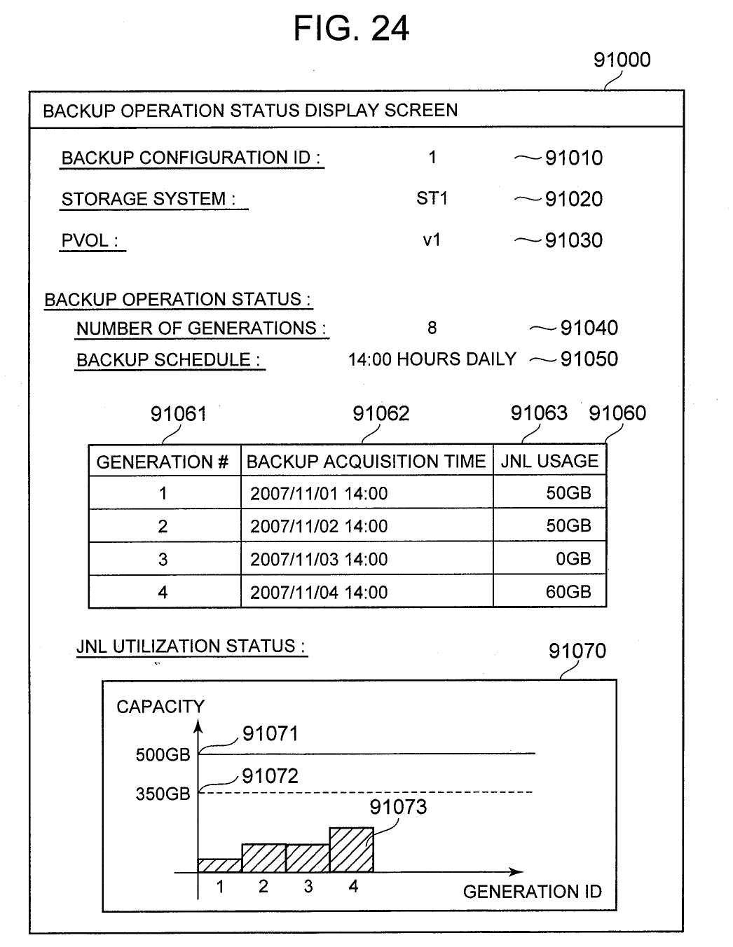

When the result of the determination on S31010 is affirmative (Step S31011: YES), the backup operation program 31000, for example, displays a warning on the output device 115 (Step S31011). Thereafter, Step S31070 is carried out. Furthermore, the warning method is not limited to the method in S31011, and various other methods can be used. For example, a warning can be displayed on a backup operation status display screen 91000 (Refer to FIG. 24), which will be explained further below, an SNMP Trap or other such message can be issued, or a warning can be outputted to a log, such as syslog.

When the result of the determination in S31010 is negative (Step S31011: NO), Step S31020 is carried out.

In Step S31020, the backup operation program 31000 determines whether or not the current time has reached the time denoted in the backup schedule. Specifically, a determination is made that the current time has reached the target time when the current time, which is discerned by the clock function of the management server 1111, is the same as or exceeds the time (hereinafter called the “target time” in the explanation of FIG. 19) denoted in the backup schedule for the target backup configuration.

If the result of the determination in S31020 is negative (Step S31020: NO), this regular processing ends, and if the result of the determination in S31020 is affirmative (Step S31020: YES), Step S31030 is carried out. Furthermore, the current time here is the time managed by the management server, but the current time can be a time managed by either the host computer 101 or the first storage system 125 instead. Further, the current time can also be a time via which the management server 1111, host computer 101, and first storage system 125 are synchronized using the NTP protocol. Synchronizing the time makes it possible to reduce the data discrepancies at a recovery point brought on by inter-device timing errors at the time of a recovery operation, which will be explained further below.

In Step S31030, the backup operation program 31000 determines whether or not the number of generations being managed for the target backup configuration exceeds the number of generations (hereinafter, the target generation threshold) specified for the target backup configuration. Specifically, for example, the backup operation program 31000 acquires the number of records (number of rows) in the backup generation management table 205, and determines whether or not this number of records exceeds the target generation threshold.

When the result of the determination in S31030 is affirmative (Step S31030: YES), Step S31031 is carried out. That is, the backup operation program 31000 issues an indication to the first storage system 125 to delete the oldest generation of JNL data and the information related thereto. Furthermore, the backup operation program 31000 deletes the records corresponding to the target backup configuration and, in addition, the above-mentioned oldest generation from the recovery point management table 41000.

When the result of the determination in S31030 is negative (Step S31030: NO), Step S31040 is carried out.

In Step S31040, the backup operation program 31000 determines whether or not there is a difference from the snapshot acquisition immediately preceding this. Specifically, the backup operation program 31000 queries the first storage system 125 as to whether or not a JNL data element has accumulated since the immediately preceding snapshot, and if the reply is that a JNL data element has accumulated, determines that there is a difference. A query mode like this can easily determine which P-VOL has changed when all P-VOL are targeted for protection or when a plurality of P-VOL are collectively protected. Or, the backup configuration management program 30000 can determine that there is no difference when a limit has been set on the backup protection-targeted file and/or folder, for example, even when the first storage system 125 has accumulated a JNL data element as a difference. For example, the backup operation program 31000 checks for the presence or absence of an archive attribute of the specified file and/or folder (hereinafter, called the “target file/folder” in the explanation of FIG. 19) by querying the backup agent program 20000, and if there is no attribute, can make the determination that there is no difference. This mode is effective for the Windows OS file system (Windows is a registered trademark). Or, the backup operation program 31000 can acquire the latest update time of the target file/folder by issuing a query to the backup agent program 20000, and can determine that there is no difference when the acquired latest update time is older than the immediately preceding snapshot acquisition time. This mode is effective with ordinary applications.

When the result of the determination in S31040 is affirmative (Step S31040: YES), Step 31050 is carried out. When the result of the determination in S31040 is negative (Step S31040: NO), Step S31041 is carried out.

In Step S31041, the backup operation program 31000 adds a new record to the recovery point management table 41000, and registers in this record as the marker insertion time the same time as the marker insertion time recorded in the record corresponding to the immediately preceding generation. That is, the backup operation program 31000 does not issue an indication to the first storage system 125 to create a snapshot. Thereafter, Step S31060 is carried out.

In S31050, the backup operation program 31000 causes the first storage system 125 to create a snapshot. Specifically, for example, first the backup operation program 31000 issues an indication to the backup agent program 20000 to execute a target backup configuration quiescence script (the script registered in the backup configuration table 40000). Next, the backup operation program 31000 communicates with the maintenance management terminal 153 of the first storage system 125, and issues an indication to execute the marker processing program 223. In addition, the backup operation program 31000 adds a new entry to the recovery point management table 41000, and registers the current time in this entry as the marker insertion time. Furthermore, as was stated above, the method for communicating with the first storage system 125 can be one that issues a command to the P-VOL via the host computer 101. Thereafter, Step S31060 is carried out.

In Step S31060, the backup operation program 31000 registers the current time in the record created in either Step S31041 or Step S31050 (the record added to the recovery point management table 41000) as the backup acquisition time.

Lastly, the backup operation program 31000 updates the backup operation status display screen 91000 (Refer to FIG. 24), which will be explained further below (Step S31070). Specifically, for example, the backup operation program 31000 outputs the information of the backup configuration table 40000 and recovery point management table 41000.

The above step ends this regular processing.

The preceding has been an explanation of the flow of processing of the backup operation program 31000. According to the above processing, since a marker is not sent from the host computer 101 to the first storage system 125 if S31041 is carried out, the processing of Step 9002 and beyond, which was explained by referring to FIG. 9, is not carried out. This makes it possible to conserve the storage capacity consumed in the first storage system 125.

Furthermore, when S31041 is carried out in this processing flow, a marker is not sent from the host computer 101 to the first storage system 125. For this reason, the number of generations managed in the management server 1111 shown in FIG. 17B is incremented by 1 (one record is added to the recovery point management table 41000), and the number of generations managed in the first storage system 125 does not increase. Therefore, it is possible that the generations managed in the management server 1111 do not correspond to the generations managed in the first storage system 125 on a one-to-one basis. Accordingly, in this embodiment, a backup acquisition time can be specified instead of a generation when specifying a recovery point. In this case, the first storage system 125 can create an R-VOL corresponding to the P-VOL of the generation that corresponds to the specified backup acquisition time. Furthermore, the “generation corresponding to the specified backup acquisition time”, for example, is the generation that is specified from the record (a record in the backup generation management table 205) in which is recorded a backup acquisition time that is either the same as or close to the specified backup acquisition time.

Next, the backup operation status display screen 91000 displayed in Step S31070 will be explained by referring to FIG. 24.

The administrator can view a backup operation status display screen 91000 like that shown in FIG. 24 while the backup operation program 31000 is carrying out regular processing. Using this screen 91000, the administrator can discern the backup operation status and JNL utilization status for respective backup configurations. Specifically, this screen 91000 has a backup configuration ID display field 91010; a first storage system 125 ID display field 91020; a P-VOL # display field 91030; the number of generations display field 91040; a backup schedule display field 91050; a backup generation information display field 91060; and a JNL utilization status display field 91070. Furthermore, instead of the P-VOL # display field 91010, a set of a hostname display field and an LU ID display field can be used. The same types of information as the information that the administrator used via the P-VOL specification in the backup configuration management process is displayed.

The values of the backup configuration table 40000 fields 40010, 40020, 40060 and 40070 are outputted to the backup configuration ID display field 91010, P-VOL # display field 91030, number of generations display field 91040, and backup schedule display field 91050. The ID of the first storage system 125, which is communicated to the maintenance management terminal, is outputted to the first storage system ID display field 91020.

The backup generation information display field 91060 has fields 91061 through 91063. The generation # (hereinafter called the “target generation #” in the explanation of FIG. 24) recorded in a record (hereinafter called the “target record” in the explanation of FIG. 24) that has the backup configuration ID in the current display of the recovery point management table 41000 is displayed in field 91061. The backup acquisition time recorded in the target record is displayed in field 91062. The JNL usage corresponding to the target generation # is displayed in field 91063. This JNL usage is the JNL usage (the JNL usage corresponding to the P-VOL # and target generation #) replied from the first storage system 125 by issuing to the first storage system 125 a query comprising the P-VOL # and target generation # that correspond to the backup configuration ID in the current display.

A cumulative value of the JNL usage in the respective generations, for example, is displayed as a bar graph in the JNL utilization status display field 91070, and, in addition, the JNL warning threshold and JNL capacity are also displayed. Consequently, the administrator can determine whether or not JNL usage exceeds the JNL warning threshold and JNL capacity by viewing this field 91070. Specifically, for example, the backup operation program 31000 adds up the JNL cumulative usage for the respective generations based on the JNL usage of each generation acquired for displaying the backup generation information in field 91060, and outputs same as bar graph 91073. More specifically, for example, in the case of FIG. 24, JNL usage of 50 GB is displayed for generation 1, and the cumulative value 100 GB, which is the 50 GB JNL usage for generation 1 and 50 GB JNL usage for generation 2, is displayed for generation 2. Similarly, the cumulative JNL usage of generation n is the cumulative value of JNL usages from generation 1 to generation (n−1). Furthermore, a generation that has already been deleted from the JNL area is treated as having a JNL usage of 0. Furthermore, the JNL capacity can be displayed as the solid line 91071, and the JNL warning threshold capacity can be displayed as the broken line 91072 using the product of the JNL capacity and JNL warning threshold (in the case of FIG. 24, 350 GB, which is 70% of 500 GB).

The preceding has been an explanation of the backup operation process. According to this process, the administrator can easily discern if the backup configuration defined by the backup configuration management process is being executed as defined, whether or not the number of generations exceeds the target generation threshold, and whether or not the JNL usage exceeds the JNL capacity and JNL warning threshold.

Furthermore, in the backup configuration management program 30000, when a limit is placed on the backup protection-targeted file and/or folder, for example, even when a JNL data element is accumulated in the first storage system 125 as a difference, it is possible to achieve a further reduction in the backup data quantity by determining there is no difference and doing away with the need to store a marker.

### <(4) Recovery Point Management Process>

Next, the recovery point management process of this embodiment will be explained.

Recovery point management processing is carried out by the recovery point management program 32000.

The recovery point management program 32000 carries out generation merge, delete and substantialize for a backup generation that has already been created.

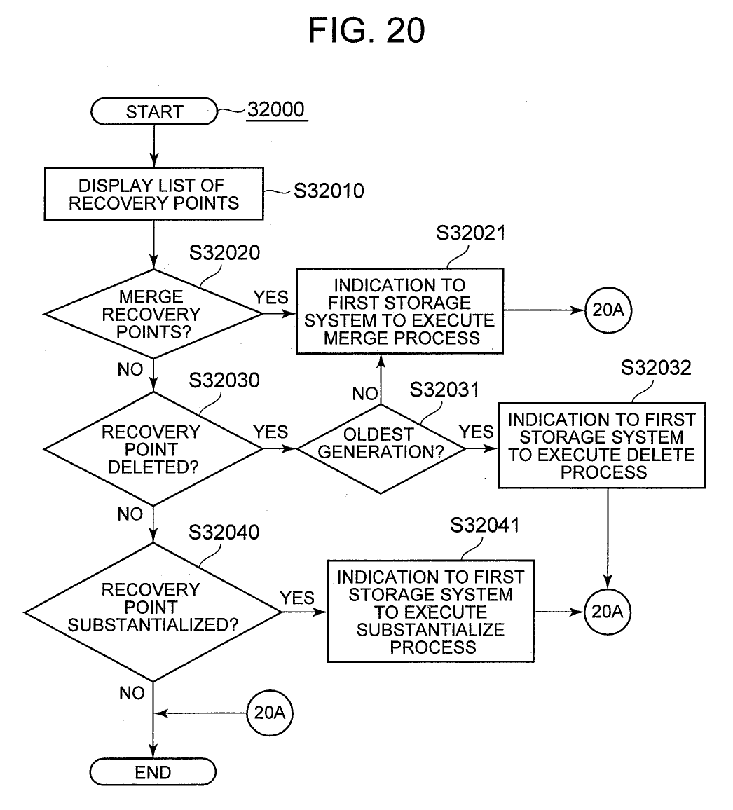

FIG. 20 shows the flow of processing of the recovery point management program 32000.

First, the recovery point management program 32000 displays a recovery point management screen, and receives a recovery point management operation from the administrator (Step S32010). An example of the recovery point management screen will be explained further below.

Next, the recovery point management program 32000 determines whether or not the indication of the administrator's recovery point management operation is a merge process (Step S32020), and if the indication is a merge process (S32020: YES), issues an indication to the first storage system to carry out merge processing (Step S32021) and ends the program. If the indication is not a merge process (S32020: NO), Step S32030 is carried out.

Next, the recovery point management program 32000 determines whether or not the indication of the administrator's recovery point management operation is a delete process (Step S32030), and if the indication is a delete process (S32030: YES), Step S32031 is carried out. If the indication is not a delete process (S32030: NO), the recovery point management program 32000 carries out Step S32040. In Step S32021, the recovery point management program 32000 determines whether or not the delete process is for the oldest generation. If the delete process is for the oldest generation (S32031: YES), the recovery point management program 32000 issues an indication to the first storage system 125 to carry out a delete process for this oldest generation (Step S32032), and the program ends. If the delete process is not for the oldest generation (S32031: NO), the recovery point management program 32000 carries out Step S32021, that is, a merge process. Specifically, upon receiving a delete process for generation m, if generation m is the oldest generation, the recovery point management program 32000 issues an indication to the first storage system 125 to carry out the delete process as-is, but if generation m is not the oldest generation, the recovery point management program 32000 issues an indication to the first storage system 125 to carry out a merge process for merging generation m with a desired generation (for example, generation (m−1)).

Next, when the administrator's recovery point management operation is a substantialize (S32040: YES), the recovery point management program 32000 issues an indication to the first storage system 125 to carry out a substantialize (Step S32041), and ends the program. If the indication is not for substantialize (S32041: NO), the program ends. As used here, “substantialize” refers to restoring the data of a certain generation m to the target device. If the target device is related to the R-VOL (virtual VOL), the generation m restore is executed by mapping the block inside the S-VOL and the area inside the JNL area to the R-VOL using an R-VOL access management table. However, when the target device is a real VOL (for example, the first real VOL), the generation m restore is executed by copying the data element inside the S-VOL and the data element inside the JNL area to the real VOL. Although making the generation m restore destination a real VOL consumes the real storage capacity of the first storage system 125, post-restore read/write performance can be expected to improve.

The preceding has been an explanation of the flow of processing of the recovery point management program 32000.

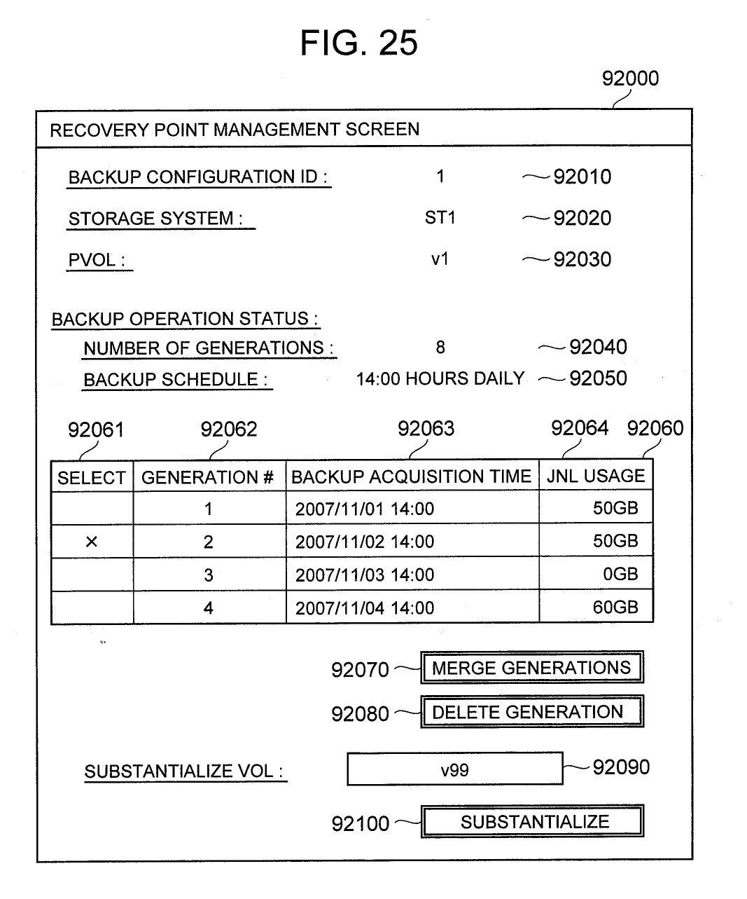

Next, the screen displayed in Step S32010 will be explained by referring to FIG. 25.

The administrator can view a recovery point management screen 92000 like that shown in FIG. 25 to carry out recovery point management as a backup operation progresses. Using this screen 92000, the administrator can issue a merge, delete, or substantialize indication for respective generations of respective backup configurations. Specifically, for example, this screen 92000 has a backup configuration ID display field 92010; a first storage system ID display field 92020; a P-VOL # display field 92030; the number of generations display field 92040; a backup schedule display field 92050; a backup generation information display field 92060; a button 92070 for issuing an indication to execute generation merge processing; a button 92080 for issuing an indication to execute generation delete processing; a field 92090 for specifying a substantialize destination; and a button 92100 for issuing an substantialize indication. Furthermore, instead of the P-VOL # display field 92010, as stated hereinabove, a set comprising a hostname field and an LU ID field can be used.

The values displayed in the backup configuration ID display field 92010, first storage system ID display field 92020, a P-VOL # display field 92030, the number of generations display field 92040, and a backup schedule display field 92050 are as was explained by referring to FIG. 24.

The backup generation information display field 92060 is the same as field 91060 of FIG. 24 with the exception that a selection field 92061 is added to field 92060 that is not found in field 91060 of FIG. 24. The administrator specifies the generation to be targeted for processing in the selection field 92061.

When the administrator selects a generation and presses button 92070, the determination result of Step S32020 becomes affirmative.

Further, when the administrator selects a generation and presses button 92080, the determination result of Step S32030 becomes affirmative.

When the administrator selects a generation, carries out inputting to field 92090 and presses button 92100, the determination result of Step S32040 becomes affirmative. Furthermore, as mentioned in the explanation of Step S32040, when the VOL to which the ID displayed in field 92090 is allocated is a virtual VOL, the respective blocks of the restored virtual VOL are mapped to either a block inside the S-VOL or an area inside the JNL area in accordance with the R-VOL access management table. Further, when the VOL to which the ID displayed in field 92090 is allocated is a real VOL, a data element stored in the block corresponding to this block inside the S-VOL, and a data element stored in the area corresponding to this block inside the JNL area are copied to respective blocks inside the real VOL. Inputting to field 92090 is the option of the administrator, and if there is no inputting in particular, the recovery point management program 32000 can execute inputting by searching for an unused virtual VOL or real VOL.

The preceding has been an explanation of the recovery point management process of the second embodiment of the present invention. According to this process, the administrator can carry out restoration to either the virtual VOL or the real VOL.

### <(5) Recovery Operation Process>

Next, the recovery operation process of this embodiment will be explained.

Recovery operation processing is realized by the recovery operation program 33000 and the backup agent program 20000.

The recovery operation program 33000 is for recovering either all the data of a specific generation inside the P-VOL, or only a modified file and/or folder of the backup generations that the administrator acquired using the backup operation program 31000. Further, although the flow of processing is not shown in the figure, the backup agent program 20000 is for receiving an indication from the recovery operation program 33000, and using configuration information related to an application or file system of the host computer 101 to specify which file and/or folder has been modified. The flow of processing of the program will be described hereinbelow.

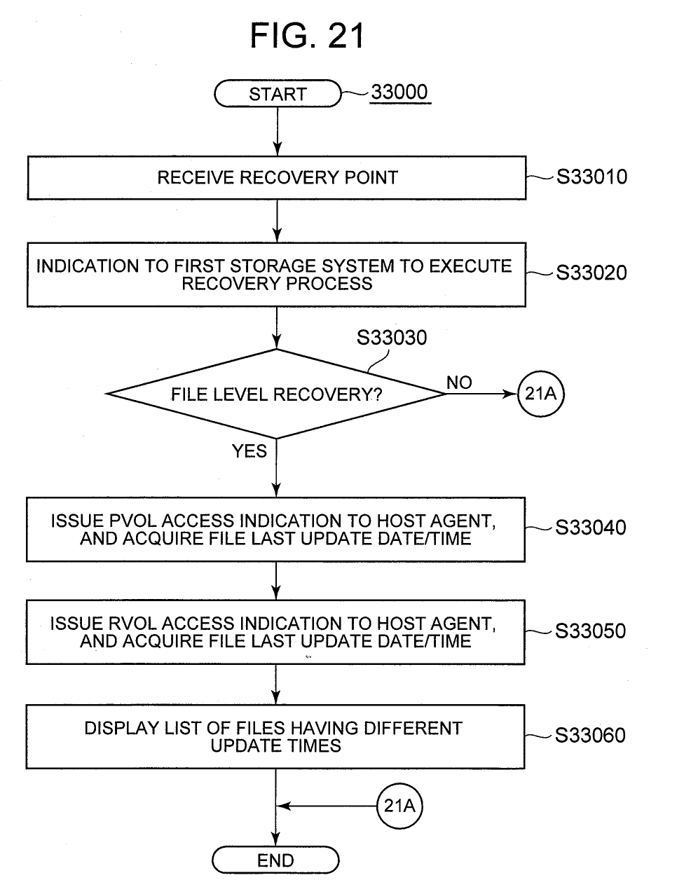

FIG. 21 shows the flow of processing of the recovery operation program 33000.

First, the recovery operation program 33000 displays a recovery operation setting screen, and receives a recovery point, which is the generation that is to be recovered (Step S33010). Specifically, an explanation of the display screen will be given further below.

Next, the recovery operation program 33000 issues an indication to the first storage system 125 for a recovery process that specifies a recovery point (Step S33020). Specifically, the recovery operation program 33000 communicates with the maintenance management terminal 153 of the first storage system 125, and issues on indication for the recovery processing of the generation (P-VOL generation) received in Step S33010. Consequently, this generation of the R-VOL is created in the first storage system 125. Furthermore, this indication can be a command issued to the P-VOL by way of the backup agent program 20000.

Next, the recovery operation program 33000 determines whether or not this was a file level recovery indication (Step S33030). Specifically, for example, the recovery operation program 33000 determines that this indication was a file level recovery indication when a limit has been placed on the backup protection targeted file and/or folder in the backup configuration management process. When the determination is that this was a file level recovery indication (S33030: YES), Step S33040 is carried out, and when the determination is that this was not a file level recovery indication (S33030: NO), the program ends.

In Step S33040, by issuing an indication to the backup agent program 20000, the recovery operation program 33000 acquires from the backup agent program 20000 the last update date/time of the current point in time file of the backup protection targeted file and/or folder (hereinafter called the target file/folder P in the explanation of FIG. 21) in the P-VOL (Step S33040). Furthermore, the last update date/time of a file is as was explained in Step S31040 of FIG. 19.

Next, by issuing an indication to the backup agent program 20000, the recovery operation program 33000 acquires from the backup agent program 20000 the last update date/time of the backup protection targeted file and/or folder (hereinafter called the target file/folder R in the explanation of FIG. 21) in the R-VOL (Step S33050).

Next, the recovery operation program 33000 compares the last update date/time acquired in Step S33040 against the last update date/time acquired in Step S33050, specifies the file that differs from the last update date/time, and displays a list of information related to the specified file (file list) (Step S33060). The R-VOL is equivalent to the P-VOL at a certain point in time of the past, but the file specified in this Step S33060 is equivalent to a pre-update file of a file that was updated subsequent to this certain point in time.

In Step S33060, the file that differs from the last update date/time is specified (the file is specified by the first method), but the file can be specified by either the second or third method instead. According to the second method, the file for which the archive attribute differs is specified, and according to the third method, the file related to the modified address area inside the R-VOL is specified.

The file/folder archive attribute can be acquired via the same method as the last update date/time acquisition method.

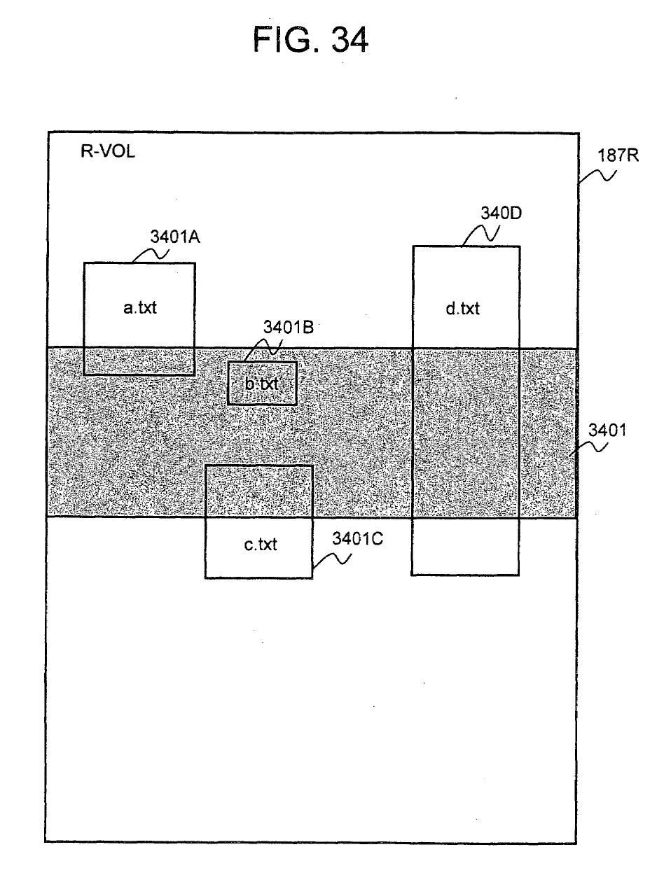

Specifying a file related to a modified address area inside the R-VOL can be realized using the following steps when the file system of the host computer 101 (and management server 1111), for example, is a UNIX file system (UNIX is a registered trademark). First, by issuing a query to the backup agent program 20000, the recovery operation program 33000 acquires the P-VOL block size from the backup agent program 20000. Next, by issuing a query to the first storage system 125, the recovery operation program 33000 extracts from the first storage system 125 all the differential BM modified bit locations from the generation of the P-VOL scheduled to be restored (recovery point) to the latest generation. Next, the recovery operation program 33000 converts all the acquired modified bit locations to the modified address area in the R-VOL. This area, for example, is calculated from the product of the number of difference bit locations and the size of the area corresponding to one bit (block size). Next, the recovery operation program 33000 determines the block number for which there was a change by converting the modified address area in the R-VOL to the block number of the file system configured by the P-VOL. This block number, for example, is the integer (quotient) obtained by dividing the size of the modified address area by the block size managed by the file system. Next, the recovery operation program 33000 converts the block number for which there was a change (the calculated block number) to an inode number for which there was a change. This inode number, for example, is calculated by executing a UNIX icheck command that treats the block number for which there was a change as an argument. Lastly, the recovery operation program 33000 converts the inode number for which there was a change to a filename for which there was a change. This filename, for example, is determined by executing a UNIX ncheck command that treats the inode number for which there was a change as an attribute. Using procedures such as those described hereinabove, it is possible to extract a filename for which there was a change even using a method that does not acquire the archive attribute or file last update date/time. Since it is possible to specify a file/folder for which there was a change subsequent to the recovery point from the data element inside the JNL area and the file system information of the current P-VOL in accordance with this method, Step S33060 can be expected to be executed without waiting for the R-VOL restore. Furthermore, modified files, which are specified using this method, are files 3403A through 3403D related to the modified address area 3401 as can be seen by referring to FIG. 34.

The preceding has been an explanation of the flow of processing of the recovery operation program 33000.

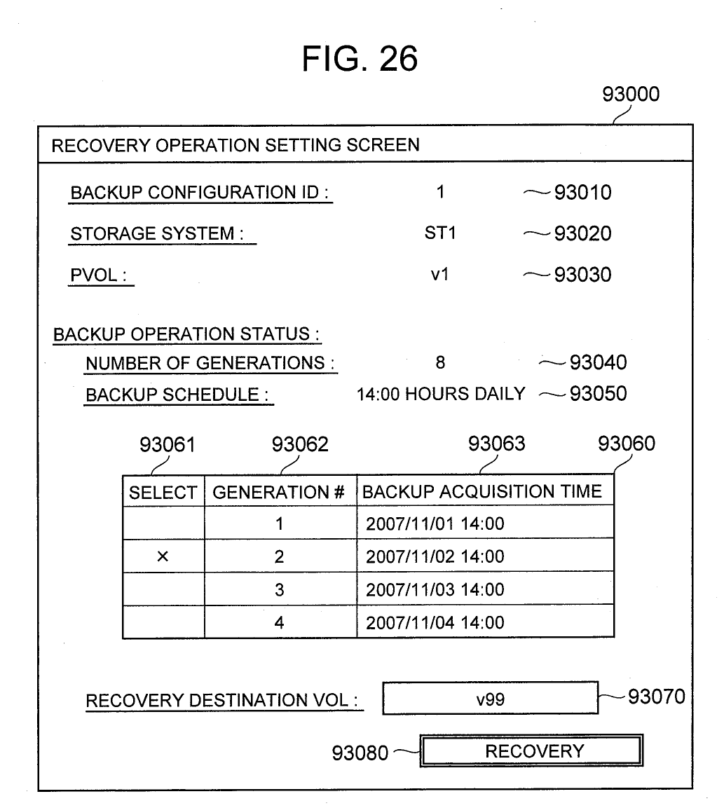

Next, an example of the screen displayed in Step S33010 will be explained by referring to FIG. 26.

The administrator can view a recovery operation setting screen 93000 like that shown in FIG. 26 when executing a recovery. The administrator can use this setting screen 93000 to indicate which generation of the P-VOL will be subjected to recovery. Specifically, this screen 93000 has a backup configuration ID display field 93010; a first storage system ID display field 93020; a P-VOL # display field 93030; the number of generations display field 93040; a backup schedule display field 93050; a backup generation information display field 93060; a field 93070 in which a recovery destination VOL # is specified; and a button 93080 for issuing an indication to execute a recovery. Furthermore, a set comprising a hostname field and an LU ID field can be used instead of the P-VOL # display field 93030.

The values displayed in fields 93010, 93020, 93030, 93040 and 93050 are as was explained by referring to FIG. 24.

The field 93060 in which backup generation information is displayed in the recovery operation state is the same as field 91060 of FIG. 24 with the exception that a selection field 93061 has been added that is not found in FIG. 24. A generation (recovery point), which is to become the target for which the hereinbelow-described process is executed, can be selected using the selection field 93061.

When the administrator selects a restore-targeted generation (recovery point), inputs a recovery destination VOL # into field 93070, and presses button 93080, the recovery operation program 33000 receives the settings in Step S33010. Furthermore, as stated in the explanation of Step S32040, when the device in field 93070 is a virtual VOL, the respective blocks inside the virtual VOL are mapped to either a block inside the S-VOL or an area inside the JNL area using the R-VOL access management table.

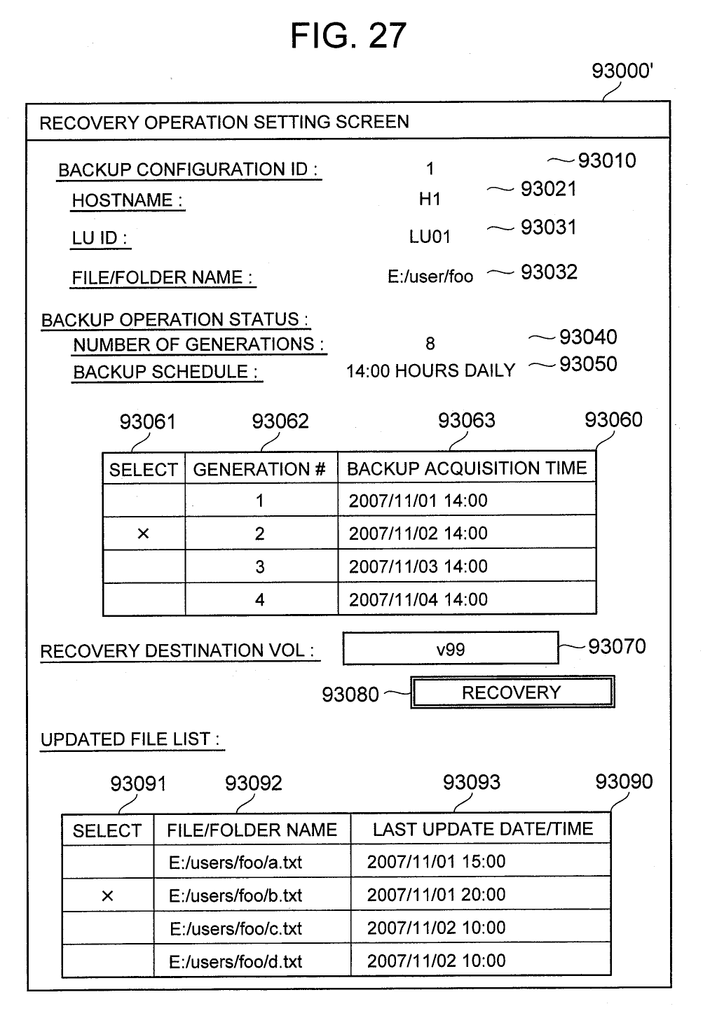

Next, a variation of the display in Step S33010 and an example of the display in Step S33060 will be explained by referring to FIG. 27. In this variation, it is supposed that the administrator specifies a backup target using a host computer and logical volume (hostname and LU ID) set instead of a P-VOL #, and, in addition, that a backup targeted file/folder is specified.

The differences with FIG. 26 are that, since the administrator specified a host computer and logical volume set and a backup target file/folder, the respective fields 93021, 93031, 93032 for displaying these are provided, and that a field 93090 for displaying a modified file list is provided.

First, when the administrator specifies the generation to be recovered (recovery point) in field 93061, inputs the recovery destination VOL # in field 93070, and presses button 93080, Step S33010 ends. Thereafter, the recovery operation program 33000 uses Steps S33040, S33050 and S33060 to compare the last update date/time of the file inside generation # “2” of the P-VOL (the P-VOL at the point in time of 14:00 hours on 2 Nov. 2007) against the last update date/time of the file inside the current P-VOL. The last update date/times of files having the same filename are compared here. As a result, as shown in FIG. 27, four files having the filenames “a.txt”, “b.txt”, “c.txt” and “d.txt” are specified as the files having different last update date/times. Accordingly, the filenames and last update date/times of these four files are displayed in field 93090. The restore file management program 33000 restores only the selected file to the specified restore destination VOL in response to the administrator selecting a desired file from among these four files and pressing button 93080.

The preceding has been an explanation of the recovery operation process of the second embodiment of the present invention. According to this process, the administrator is able to restore only a desired file without restoring all the data elements of the R-VOL. It is thus possible to shorten the time required for a restore.

### Embodiment 3

The above-described second embodiment makes it possible to reduce the amount of backup data stored up inside the first storage system using programs installed in the host computer and management server.

As used here, holding backup data in the first storage system constitutes storing the backup data in a hard disk drive (or flash memory). However, since the so-called bit cost is less expensive with a tape, if backup data is to be held for a long period of time, it is conceivable that a method in which the backup data is saved to a tape device from the first storage system can be used.

Accordingly, in a third embodiment, the backup data is transferred from the first storage system to a tape storage system. In so doing, the backup data to be transferred is transferred in file units rather than block units. A data restore is also carried out in file units rather than block units. Furthermore, the backup destination of the backup data is not limited to a tape device, and another type of storage device with lower bit costs than the PDEV comprising the first storage system 125 can be used. Further, backing up backup data outside the first storage system is also advantageous in that the backup data can be restored even if a failure should occur in the first storage system. Therefore, the backup destination is not limited to a low bit cost PDEV, and a high bit cost PDEV that features high reliability can also be used as the backup destination.

The following explanation of the third embodiment will focus mainly on the points of difference with the second embodiment, and explanations of points held in common with the first embodiment will be simplified or omitted.

### <(1) Overview of the Third Embodiment and Configuration of the Computer System>

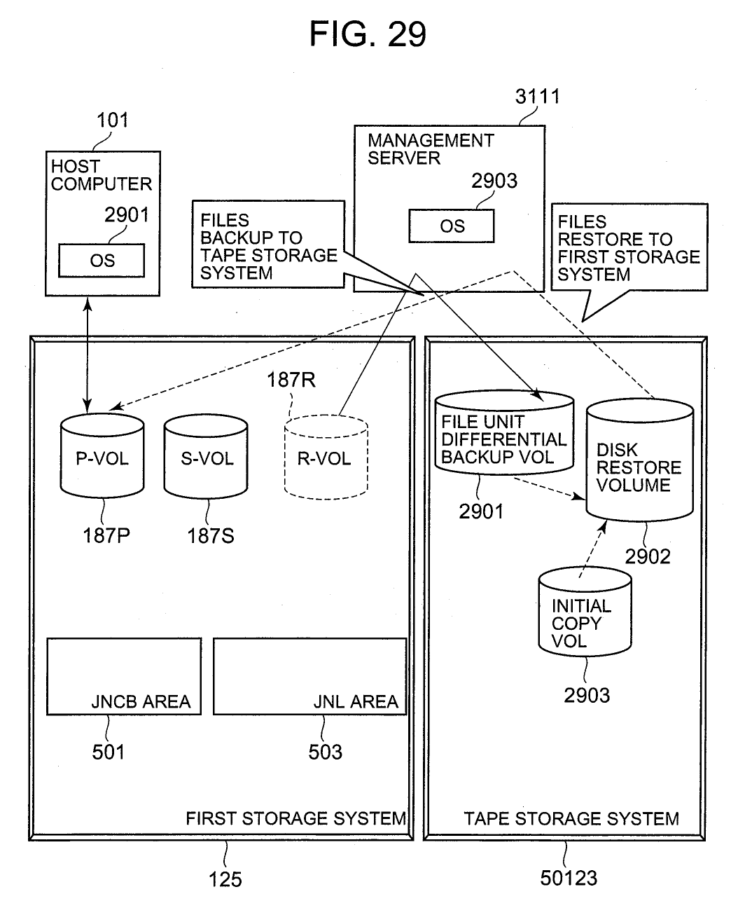

FIG. 29 shows an overview of the third embodiment.

For example, a management server 3111 comprises the same kind of operating system (OS)(for example, UNIX) 2913 as the OS 2911 executed by the host computer 101. Thus, the management server 3111 can recognize the same file that the host computer 101 recognizes (the second embodiment can also be constituted like this). Specifically, for example, the management server 3111 can mount P-VOL and R-VOL, and can reference the P-VOL and R-VOL in S33040 and S33050 of FIG. 21.

The management server 3111 copies all the data at the point in time of the start of a backup data operation of P-VOL 187P in a tape storage system 50123 in response to an indication from the administrator. This copy destination VOL (a VOL inside the tape storage system 50123) will be called the “initial copy VOL” hereinafter.

Upon receiving a backup indication from the administrator, the management server 3111 creates an R-VOL 187R that corresponds to the generation of the P-VOL (hereinafter, backup generation) specified in the backup indication, and backs up data from this R-VOL in file units to a file unit differential backup VOL 2901 inside the tape storage system 50123. The data to be backed up is only one or more files (hereinafter, the difference file) corresponding to the difference between the current P-VOL 187P and the R-VOL 187R that corresponds to the backup generation. The one or more files can be files configured from a plurality of block data, or files configured from block data residing in the S-VOL 187S and block data residing in the JNL area 503. Therefore, an aggregate of block data acquired from the S-VOL 187S and block data acquired from the JNL area 503 can be backed up as a difference file in the file unit differential backup VOL 2901 inside the tape storage system 50123. The “file unit differential backup VOL” is a volume in which a difference file is stored. File unit differential backup VOL 2901 is a logical storage device created on the basis of one or more tapes inside the tape storage system 50123.

Upon being issued an indication from the administrator to restore a certain backup generation of the P-VOL (for example, backup generation K, which is the same as the backup generation corresponding to R-VOL 187R), the management server 3111 creates a disk restore volume 2902 inside the tape storage system 50123, and copies the data inside the disk restore volume 2902 to the P-VOL 187P inside the first storage system 125. The copy destination can also be another VOL. When another VOL is the copy destination, this other VOL is mounted to the host computer 101 subsequent to copying, and this other VOL is used as a P-VOL.

What is referred to as “disk restore” in this embodiment signifies a restore that is different from the restore via which the R-VOL is created in the first storage system 125. The “disk restore volume” is the disk restore destination volume.

Firstly, all of the files inside the initial copy VOL 2903 are stored in the disk restore volume 2902, and thereafter files from the generation corresponding to the initial copy VOL 2903 up to backup generation K are stored in order in the disk restore volume 2902. Accordingly, the file group inside the disk restore volume 2902 constitutes the same file group as the file group inside backup generation K of the P-VOL.

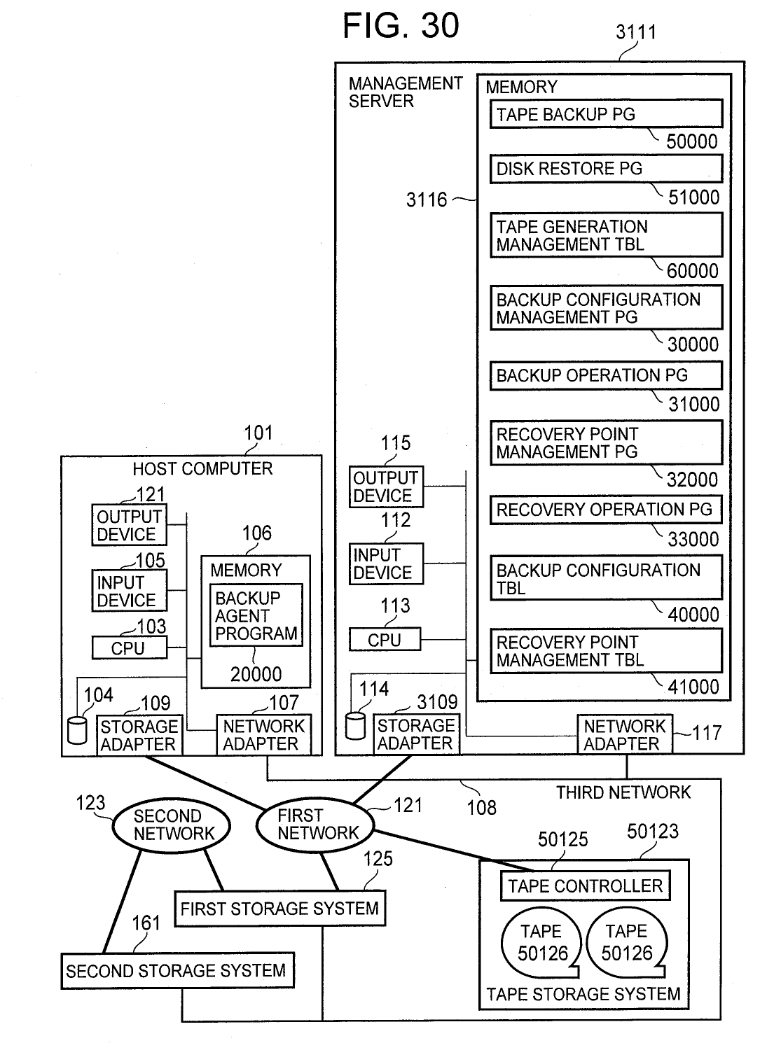

FIG. 30 shows the configuration of the computer system related to the third embodiment. In this figure, program is abbreviated as “PG”, and table is abbreviated as “TBL”. Further, the OS 2911 and 2913 shown in FIG. 29 are omitted from the figure.

The tape storage system 50123 has a tape controller 50125; and a plurality of tapes (magnetic tape devices) 50126. The tape controller 50125, in response to an indication from the management server 3111, creates the above-described file unit differential backup VOL 2901, disk restore volume 2902 and initial copy VOL 2903 as VOL that are based on these tapes 50126.

The management server 3111 has a storage adapter 3109, and this storage adapter 3109 is connected to a first network 121. Consequently, the management server 3111 is able to recognize a VOL inside the first storage system 125 via the first network 121. Specifically, the management server 3111 is able to access the R-VOL 187R and P-VOL 187P inside the first storage system 125, and is also able to access the file unit differential backup VOL 2901, disk restore volume 2902 and initial copy VOL 2903 inside the tape storage system 50123. In addition to the programs and tables explained in the second embodiment, a tape backup PG 50000, disk restore PG 51000, and a tape generation management TBL 60000 are also stored in the memory 3116 of the management server 3111.

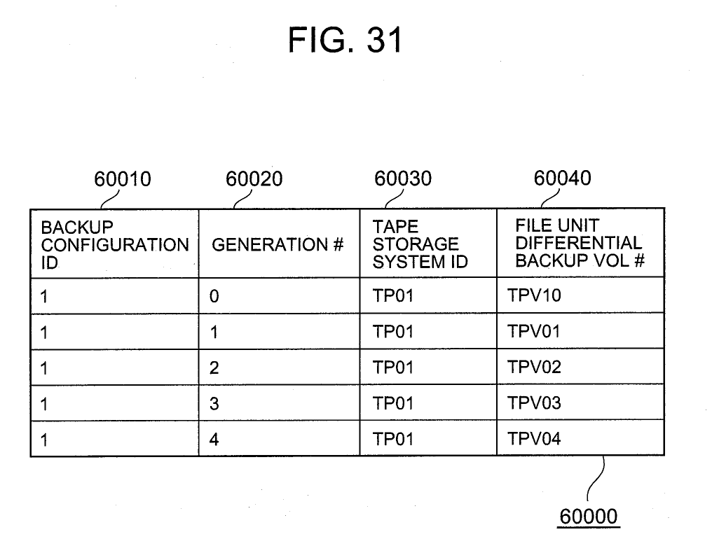

FIG. 31 shows an example of the tape generation management TBL 60000.

This table 60000 is for managing the VOL which is the difference accumulation VOL for each backup configuration and generation set. The difference accumulation VOL is a typical file unit differential backup VOL, but in the first generation (early generation) is a duplicate VOL (initial copy VOL) of the early generation of the P-VOL. This TBL 60000 comprises a field 60010 in which a backup configuration ID is registered; a field 60020 in which a generation # is registered; a field 60030 in which a tape storage system ID is registered; and a field 60040 in which the number of a difference accumulation VOL is registered. Furthermore, since generation # “0” signifies the early generation, the difference storage VOL # corresponding to generation # “0” is the number of the initial copy VOL.

### <(2) Tape Backup Process of Third Embodiment>

Next, the tape backup process of the third embodiment will be explained.

Backup configuration management processing is carried out by the tape backup PG 50000. The tape backup PG 50000 is for backing up a certain generation difference file to the file unit differential backup VOL 2901.

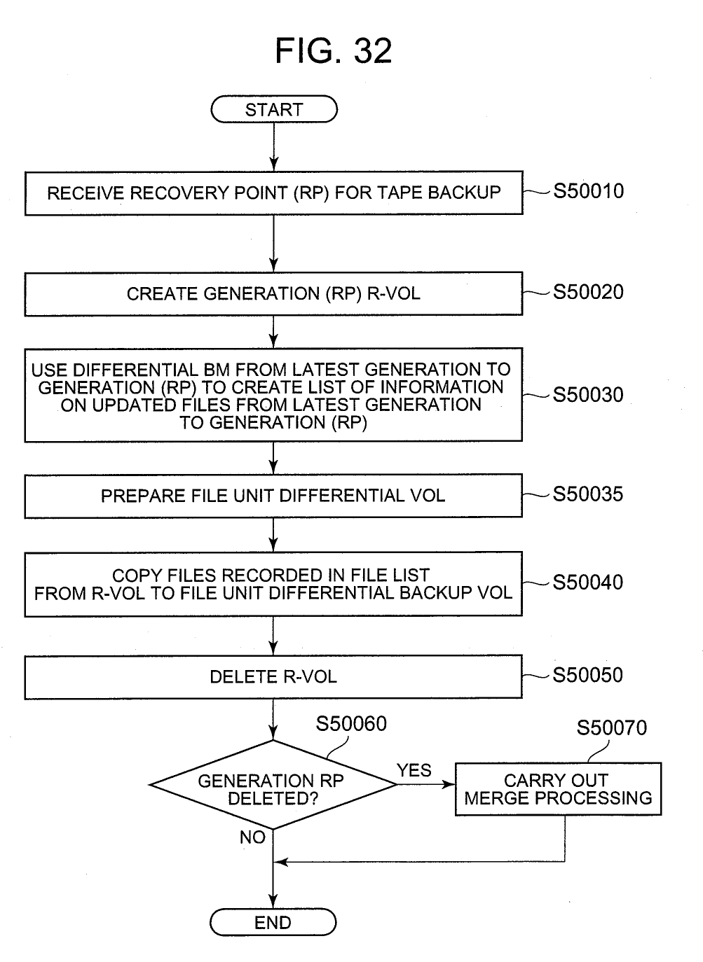

FIG. 32 is a diagram showing the flow of processing of the tape backup PG 50000.

The tape backup PG 50000 receives specifications from the administrator for a P-VOL and generation (RP) (recovery point) (Step S50010).

Next, the tape backup PG 50000 creates an R-VOL corresponding to generation (RP) of the P-VOL (Step S50020). In this Step S50020, for example, an R-VOL access management table corresponding to this R-VOL is created as explained by referring to FIG. 13.

Next, the tape backup PG 50000 uses the differential BM from the latest generation up to generation (RP) to create a list of information (hereinafter, the file list) related to updated files from the latest generation up to generation (RP) (Step S50030). The method for creating this list is the same as that based on the third method described in the explanation that referred to FIG. 21. Information related to all the specified files is registered in the file list.

Next, the tape backup PG 50000 prepares a file unit differential backup VOL in the tape storage system 50123 (Step S50035). Specifically, for example, the tape background PG 50000 defines a file unit differential backup VOL based on an unused tape (a tape that is not based on a logical volume) 50126 inside the tape storage system 50123. The tape backup PG 50000 adds the generation (RP) record to the tape generation management TBL 60000, and registers a backup configuration ID (ID of the backup configuration comprising the specified P-VOL), generation # (generation (RP) number), tape storage system ID, and difference accumulation VOL # (number of the defined file unit differential backup VOL) in this record.

Next, the tape backup PG 50000 copies the difference file specified from the information recorded in the file list created in Step S50030 from the R-VOL created in Step S50020 to the file unit differential backup VOL created in Step S50035 (Step S50040). Specifically, for example, the tape backup PG 50000 reads the difference file from the R-VOL, and writes the read difference file to the file unit differential backup VOL.

Next, the tape backup PG 50000 deletes the R-VOL created in Step S50020 (Step S50050). Specifically, the tape backup PG 50000 deletes the R-VOL access management table corresponding to the R-VOL. Further, when the restore differential BM, which was used to merge differential BM from the differential BM corresponding to the latest generation up to generation (RP) in order to create the R-VOL, has been created, this restore differential BM is also deleted.

Next, the tape backup PG 50000 queries the administrator as to whether or not inter-generational difference data related to generation (RP) is to be deleted (Step S50060). Only when the administrator selects delete (S50060: YES) does the tape backup PG 50000 execute generation (RP) merge processing in the first storage system 125 (Step S50070). Furthermore, in the case of S50060: YES, the inter-generational difference data of all the generations prior to generation (RP) is also deleted.

The preceding has been an explanation of the flow of processing for the tape backup PG 50000. A difference file backup up from the first storage system 125 to the tape storage system 50123 can be deleted from the first storage system.

### <(3) Disk Recovery Process>

Next, the disk recovery process of this embodiment will be explained.

Disk recovery operation processing is carried out by the disk recovery PG 51000.

The disk recovery PG 51000 is for enabling the recovery of only a modified file/folder of an administrator desired generation from among the generations backed up in the tape storage system.

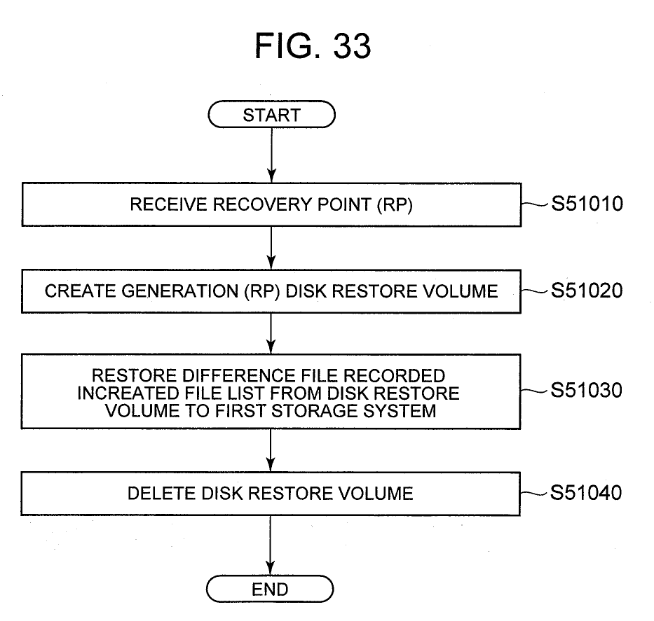

FIG. 33 shows the flow of processing of the disk recovery PG 51000.

First, the disk recovery PG 51000 receives specifications for a P-VOL and a recovery point (hereinafter, stated as generation (RP)) to be subjected to disk restore from the administrator (Step S51010).

Next, the disk recovery PG 51000 creates a disk restore volume for generation (RP) (Step S51020). Specifically, for example, the disk recovery PG 51000 newly defines a disk restore volume 2902 of the same capacity as the specified P-VOL inside the tape storage system 50123. Then, the disk recovery PG 51000 copies all the files inside the initial copy VOL (the VOL in the tape generation management TBL 60000 identified from the difference accumulation VOL # corresponding to generation # “0”) 2903 to the disk restore volume 2902. Thereafter, the disk restore volume 2902 copies all the files inside the file unit differential backup VOL up to generation (RP) to the disk restore volume 2902 in order from the file inside the file unit differential backup VOL corresponding to the oldest generation (a file having the same filename as a subsequently copied file will be overwritten by the file that is copied subsequently thereto).

Next, of the plurality of files stored in the disk restore volume 2902, the disk recovery PG 51000 restores only the difference file recorded in the created file list from the disk restore volume 2902 to P-VOL 187P inside the first storage system 125 (Step S51030). Specifically, the disk recovery PG 51000 reads the difference file specified by the file list from the disk restore volume 2902, and writes the read difference file to the P-VOL inside the first storage system 125. The write destination can be a VOL other than the P-VOL, for example, the S-VOL or R-VOL.

The preceding has been an explanation of the flow of processing of the disk recovery PG 51000.

This embodiment can be expected to reduce the capacity consumed in the JNL area 503, and to reduce the bit cost for storing an amount of backup data. Further, since the backup data transferred from the first storage system 125, as well as the data restored from the tape storage system 50123 are difference files, it is possible to reduce the time required for a backup and a restore. In addition, in this embodiment, since a backup is carried out in file units instead of block units, a restore in file units like that described above is possible.

A number of embodiments of the present invention have been explained hereinabove, but these embodiments are examples for explaining the present invention, and do not purport to limit the scope of the present invention solely to these embodiments. The present invention can be put into practice in a variety of other modes.

For example, in any of the first through the third embodiments, the computer system can be an open system or a mainframe system.

Further, for example, storage system 125 and/or 161 can be a NAS (Network Attached Storage).

Further, for example, the journal can be a so-called before journal (journal comprising pre-update data) instead of a so-called after journal (journal comprising post-update data).

Further, for example, the computer programs provided in the management server in the second and third embodiments can be provided in another location (for example, the host computer) instead of the management server.

Further, the S-VOL can be eliminated. In this case, the reference destination when the R-VOL is accessed is either a block inside the P-VOL or a segment in which an online update difference data element is stored instead of the block inside the S-VOL. Further, in this case, when a marker is received, the online update difference data will constitute inter-generational difference data. Online update difference data elements read out from a JNL sub-area in address order as a sort process at this time are written to another JNL sub-area in address order. Sort processing is easy if there is an S-VOL, but if there is no S-VOL, storage capacity consumption can be reduced by the size of the S-VOL.

1. A backup system comprising:
a storage system having a first logical volume that is accessed from a host computer; and
a backup controller that controls a data backup inside the first logical volume,
the storage system comprising:
a physical storage device that constitutes a basis for one or more logical volumes including the first logical volume and; and
a controller, which has a memory, and which receives a write command and a write data element from the host computer, and writes the write data element to the first logical volume specified from the write command,
the journal area being a storage area in which is stored a journal data element, which is either a data element that is stored in any block of a plurality of blocks that configure a logical volume, or a data element that is written to this block,
the host computer sending a marker, which is a snapshot acquisition request, to the storage system upon receiving a marker insert indication, which is a snapshot create indication, from the backup controller,
the controller, upon receiving the marker from the host computer, executing a generation determination process for determining a generation of the first logical volume, and writing information related to the generation determined in the generation determination process to the physical storage device and/or the memory, and
the backup controller:
(1-1) determining whether or not any data or specified file and/or folder inside the first logical volume of an immediately preceding generation has changed;
(1-2) sending the marker insert indication to the host computer when a result of the determination in the (1-1) is affirmative; and
(1-3) not sending the marker insert indication to the host computer when the result of the determination in the (1-1) is negative.

2. The backup system according to claim 1, wherein, in addition to the first logical volume, a second logical volume that forms a pair with the first logical volume is provided;
a journal management area is provided as a storage area based on the physical storage device;
first sub-management information is stored in the journal management area for the first logical volume;
second sub-management information for each generation is stored in the journal management area for the second logical volume;
the first sub-management information includes first difference management information that has information elements corresponding to respective blocks configuring the first logical volume, and the respective information elements denote whether or not an update has occurred in a block corresponding to each information element;
the second sub-management information includes second difference management information that has information elements corresponding to respective blocks configuring the second logical volume, and data storage address information, the respective information elements denote whether or not an update has occurred in a block corresponding to each information element, and the data storage address information denotes an address of a segment in the journal area; and
the memory stores management information that denotes the locations of the information of both the first sub-management information and the second sub-management information for each generation,
the controller having:
a write processor that receives the write command and the write data element from a higher-level device, writes the write data element to a write-destination block inside the first logical volume specified from the write command, and when the information element corresponding to the write-destination block in the first difference management information is denoted as not updated, updates this information element; and
a generation determination unit that executes the following (2-1) and (2-2) when generation (j) of the first logical volume has been determined in accordance with receiving the marker:
(2-1) adding the second sub-management information (j−1), which includes the second difference management information (j−1) corresponding to a generation (j−1) of the second logical volume, to the inside of the journal management area; and
(2-2) executing (2-2-1) through (2-2-4) below for the respective information elements denoting that updating has been completed for the first difference management information:
(2-2-1) updating an information element inside the second difference management information (j−1), which corresponds to an information element denoting that updating has been completed for the first difference management information, to an information element denoting that updating has been completed;
(2-2-2) adding data storage address information to the second sub-management information, and the added data storage address information denotes the save-destination segment address in the journal area of a data element stored in the block inside the second logical volume, which is in the same location as a block corresponding to the information element denoting that updating has been completed for the first difference management information;
(2-2-3) saving the data element stored in a block inside the second logical volume, which is in the same location as a block corresponding to the information element denoting that updating has been completed for the first difference management information, to a segment inside the journal area that denotes the added data storage address information; and
(2-2-4) writing the data element related to the first logical volume that corresponds to the information element denoting that updating has been completed for the first difference management information to a segment inside the second logical volume, which is a save destination of the data element, and
defining the aggregate of data elements saved to the journal area in the (2-2-3) as inter-generational difference data (j−1) that denotes a difference between the second logical volume of the generation (j−1) and the second logical volume of the generation (j−2).

3. The backup system according to claim 2, wherein the controller further comprises a merge processor that carries out a merge process, which is a process for merging the second sub-management information of a plurality of generations and inter-generational difference data;
the post-merge second sub-management information and inter-generational difference data include an older generation information element and inter-generational difference data element for the information element and inter-generational difference data element corresponding to the same block, but do not include an information element and inter-generational difference data element that are newer than the old generation element, and
one end generation of the plurality of generations is the generation corresponding to the recovery point.

4. The backup system according to claim 3, further comprising a recovery point manager, wherein
the recovery point manager, upon receiving from an administrator a delete indication specifying a recovery point, sends a merge indication that specifies the recovery point to the storage system when the recovery point does not correspond to the oldest generation, and
the merge processor carries out the merge processing in response to the merge indication.

5. The backup system according to claim 2, wherein the controller comprises:
a size receiving unit that receives a write unit size, which is a size of a write data element received from the higher-level device; and
a size setting unit that sets the received write unit size in the memory, for the one or more logical volumes,
a size of a journal data element stored in the journal area, which is based on the set write unit size, is the write unit size, and
the respective blocks are of the write unit size.

6. The backup system according to claim 1, wherein
the backup controller has a computer that is connected to the storage system,
the computer has a storage resource, and the storage resource stores backup management information denoting marker insertion time for each generation of the first logical volume for a backup configuration including the first logical volume, and
the backup controller registers the current time in the backup management information as the current marker insertion time when the result of the determination in the (1-2) is affirmative, and registers the same time as the marker insertion time corresponding to the immediately preceding generation as the current marker insertion time when the result of the determination in the (1-2) is negative.

7. A management computer that is connected to:
a host computer; and
a storage system, which has a first logical volume that is accessed by the host computer, a physical storage device that constitutes a basis for one or more logical volumes including the first logical volume, and has a memory, and upon receiving a marker, which is a snapshot acquisition request, from the host computer, executes a generation determination process for determining a generation of the first logical volume, and writes information related to the generation determined in the generation determination process to the physical storage device and/or the memory,
the management computer comprising:
a backup controller, which has a determination unit that determines whether or not all the data inside the first logical volume in the immediately preceding generation or a specified file and/or folder have changed, and which sends the marker insert indication to the host computer when the result of the determination is affirmative, and does not send the marker insert indication to the host computer when the result of the determination is negative.

8. A backup system comprising:
a storage system having a first logical volume that is accessed from a host computer;
another storage system that is connected to the storage system; and
a backup controller that controls a backup of data that is inside the first logical volume,
the storage system comprising:
a physical storage device that constitutes a basis of one or more logical volumes including the first logical volume and a journal area; and
a controller, which has a memory, and which receives a write command and write data element from the host computer and writes the write data element to the first logical volume specified from the write command,
the journal area being a storage area in which is stored a journal data element, which is either a data element that is stored in any block of a plurality of blocks that configure a logical volume, or a data element that is written to this block,
the controller having a restore processor that creates a restore volume corresponding to the first logical volume in a certain generation, and
the backup controller:
(8-1) specifying a file and/or folder that has changed from the certain generation to the latest generation by comparing the restore volume with the first logical volume; and
(8-2) backing up only the file and/or folder specified in the (8-1) of the data inside the restore volume to the other storage system.

9. The backup system according to claim 8, comprising a restore controller, wherein
the backup controller executes the (8-1) and (8-2) subsequent to copying all of the files inside the first logical volume in an early generation to a third logical volume inside the other storage system,
the backup destination in the (8-2) is a fourth logical volume that has been associated with the certain generation, and
the restore controller creates a fifth logical volume having the same capacity as the first logical volume in the other storage system, copies all the files inside the third logical volume to the fifth logical volume, and thereafter copies all the files inside the fourth logical volume, which has been associated with a generation corresponding to the recovery point, to the fifth logical volume, and, of the file group inside the fifth logical volume, copies only the file that corresponds to the difference with the first logical volume to either the first logical volume or another logical volume inside the storage system.

10. The backup system according to claim 9, wherein
in addition to the first logical volume, a second logical volume that forms a pair with the first logical volume is provided;
a journal management area is provided as a storage area based on the physical storage device;
first sub-management information is stored in the journal management area for the first logical volume;
second sub-management information for each generation is stored in the journal management area for the second logical volume;
the first sub-management information includes first difference management information that has information elements corresponding to the respective blocks configuring the first logical volume, and the respective information elements denote whether or not an update has occurred in the block corresponding to each information element;
the second sub-management information includes second difference management information that has information elements corresponding to the respective blocks configuring the second logical volume, and data storage address information, the respective information elements denote whether or not an update has occurred in a storage area corresponding to each information element, and the data storage address information denotes an address of a segment in the journal area; and
the memory stores management information that denotes locations of the information of both the first sub-management information and the second sub-management information for each generation,
the controller having:
a write processor that receives the write command and the write data element from the higher-level device, writes the write data element to a write-destination block inside the first logical volume specified from the write command, and when the information element corresponding to the write-destination block in the first difference management information is denoted as not updated, updates this information element; and
a generation determination unit that executes the following (10-1) and (10-2) when generation (j) of the first logical volume has been determined in accordance with the occurrence of a generation determination event:
(10-1) adding the second sub-management information (j−1), which includes the second difference management information (j−1) corresponding to a generation (j−1) of the second logical volume, to the inside of the journal management area; and
(10-2) executing (10-2-1) through (10-2-4) below for the respective information elements denoting that updating has been completed for the first difference management information:
(10-2-1) updating an information element inside the second difference management information (j−1), which corresponds to an information element denoting that updating has been completed for the first difference management information, to an information element denoting that updating has been completed;
(10-2-2) adding data storage address information to the second sub-management information, and the added data storage address information denoting the save-destination segment address in the journal area of a data element stored in the block inside the second logical volume, which is in the same location as the block corresponding to the information element denoting that updating has been completed for the first difference management information;
(10-2-3) saving the data element stored in a block inside the second logical volume, which is in the same location as a block corresponding to the information element denoting that updating has been completed for the first difference management information, to a segment inside the journal area that denotes the added data storage address information; and
(10-2-4) writing the data element related to the first logical volume, which corresponds to the information element denoting that updating has been completed for the first difference management information, to the segment inside the second logical volume, which is the save destination of the data element, and
the aggregate of data elements saved to the journal area in the (10-2-3) being inter-generational difference data (j−1) denoting the difference between the second logical volume in the generation (j−1) and the second logical volume of the generation (j−2).

11. The backup system according to claim 10, wherein the restore processor uses the second sub-management information from the certain generation up to the latest generation to create restore management information having respective reference destination addresses corresponding to the respective blocks that configure the restore volume, which is a virtual logical volume, and when a certain block of the restore volume is a read source and there is a valid reference destination address in the certain block, reads out a data element from the segment this reference destination address shows, and when there is no valid reference destination address in the certain block, reads out a data element from the block in the same location as the certain block in either the first or second logical volume, and
a file corresponding to the difference is configured from at least one of the data element read out from the segment and the data element read out from the block inside either the first or the second logical volume.

12. The backup system according to claim 11, wherein
the controller further comprises a merge processor that carries out a merge process, which is a process for merging the second sub-management information in a plurality of generations and inter-generational difference data,
the post-merge second sub-management information and inter-generational difference data include an older generation information element and inter-generational difference data element for the information element and inter-generational difference data element corresponding to the same block, but do not include an information element and inter-generational difference data element that are newer than the old generation element, and
one end generation of the plurality of generations is a generation corresponding to the recovery point.

13. The backup system according to claim 9, wherein the controller comprises:
a size receiving unit that receives a write unit size, which is a size of a write data element received from a higher-level device; and
a size setting unit that sets the received write unit size in the memory for the one or more logical volumes,
a size of a journal data element stored in the journal area, which is based on the set write unit size, is the write unit size, and
the respective blocks are of the write unit size.
